(19) United States
(12) Patent Application Publication
(10) Pub. No.: US 2009/0231711 A1
(43) Pub. Date: Sep. 17, 2009

(54) DIFFRACTION GRATING LOW-PASS FILTER

(76) Inventor: Makoto OHMURA, Saitama-shi (JP)

Correspondence Address: BIRCH STEWART KOLASCH & BIRCH, PO BOX 747, FALLS CHURCH, VA, 22040-0747, US

(21) Appl. No.: 12/362,276

(22) Filed: Jan. 29, 2009

(30) Foreign Application Priority Data
Mar. 12, 2008 (JP) P2008-062417

(51) Int. Cl. G02B 5/20; G02B 5/18

(52) U.S. Cl. 359/569; 359/568; 359/566

(57) ABSTRACT

In the diffraction grating low-pass filter, the diffraction grating has a refractive index variation region having a refractive index different from that of the glass substrate and having a lattice shape in the glass substrate, and the refractive index variation region includes a plurality of phases depending on differences of optical path lengths. Furthermore, in the diffraction grating low-pass filter, a region having an array of two rows and two columns in which regions of phases 0 and 2φ are arranged in one diagonal direction and regions of phases φ and 3φ are arranged in the other diagonal direction is set as a unit grating. Assuming that m is any one of integers of 1 to 3, the unit grating satisfies the following conditional expression: |mφ−mπ/2|≦(mπ/2)/5

The present invention claims priority from Japanese Patent Application No. 2008-062417 filed on Mar. 12, 2008, the entire content of which is incorporated herein by reference.

### BACKGROUND OF INVENTION

1. Field of the Invention

The present invention relates to a diffraction type optical element for separating luminous flux by diffraction effect, and more particularly to an optical low-pass filter (OLPF) of a solid-state imaging device such as CCD (Charge Coupled Device) or CMOS (Complementary Metal Oxide Semiconductor).

2. Description of the Related Art

Recently, as personal computers become popular in regular families, there is rapidly spread a digital still camera (which is hereinafter referred to as a digital camera simply) which may input image information about scenes, persons and the like photographed into the personal computer. Also, as the performance of a portable cellular phone is enhanced, the incorporation of a module camera for inputting images into a portable cellular phone (a module camera for a portable cellular phone) is increasing.

In these imaging apparatuses, there are used solid-state imaging devices such as a CCD and a CMOS. In such solid-state imaging devices, imaging pixels are discretely and 2-dimensionally arranged. An optical system having such a solid-state imaging device uses an OLPF for suppressing occurrence of undesirable colors and Moire pattern caused by high frequency components included in a subject. A known diffraction grating low-pass filter 100 has a structure in which a retardation plate 101 such as a quarter wavelength plate is interposed between two crystal plates 102 A and 102 B as shown in FIG. 33. The filter performs a function of separating incident luminous flux by using birefringence effect of crystal (for example, see JP-A-H10-54960).

Furthermore, a diffraction type OLPF for separating luminous flux by using diffraction effect is proposed (see JP-A-07-198921, JP-A-2005-77966, JP-A-2006-30954, and JP-B-3204471). The diffraction type OLPF (hereinafter, it is referred to as a diffraction grating low-pass filter) is formed as a diffraction grating. A surface of the grating has a concavo-convex shape like the diffraction grating low-pass filter 103 as shown in FIG. 34, for example. In addition, a section of the surface has a rectangular wave shape, a triangular wave shape, a trapezoidal wave shape, a trigonometric wave shape (a sinusoidal wave shape), or a multi-valued binary shape.

However, in the diffraction grating low-pass filter 100 using crystal plates, a thickness of the whole system increases since the filter is formed by attaching and matching a plurality of optical elements. Thus, the filter is in advantageous in downsizing of an imaging apparatus. Furthermore, in the diffraction grating low-pass filter 103, the surface thereof has a concavo-convex shape and is disposed close to the imaging device. Thus, Moire pattern occurs between the diffraction grating low-pass filter 103 and the imaging device. In addition, light having a diffraction angle approximate to a total reflection angle exists in a rear surface of the diffraction grating low-pass filter 103. Thus, a so-called flare is caused by light totally reflected between the imaging surface of the imaging device and the rear surface of the diffraction grating low-pass filter 103. Hence, JP-A-07-198921, JP-A-2005-77966, JP-A-2006-30954, and JP-B-3204471 show various solutions for suppressing occurrence of flare and Moire pattern. Also, problems arise that diffraction efficiency is changed by a wavelength of incident light and illumination intensity fluctuation occurs in the surface of the imaging device. As a result, illumination intensity fluctuation occurs, or colors are unbalanced, whereby image quality of obtained images deteriorates.

### SUMMARY OF INVENTION

The present invention is made in consideration of the related problems. Thus, it is desirable to provide a diffraction grating low-pass filter capable of achieving a decrease in thickness as compared with the case of using a crystal plate and suppressing deterioration in image quality even when using a diffraction grating.

According to a first aspect of the invention, a diffraction grating low-pass filter is provided with a transparent substrate; and a diffraction grating portion provided in the transparent substrate, wherein the diffraction grating portion has a refractive index variation region having a refractive index different from that of the transparent substrate and includes a plurality of unit gratings, and wherein each of the plurality of unit gratings includes a plurality of regions which is arranged in two rows and two columns and which have phases depending on optical path lengths between the regions.

In the diffraction grating low-pass filter and the imaging apparatus according to the aspect of the invention, the diffraction grating portion has a refractive index variation region having a refractive index different from that of the transparent substrate and including a plurality of phases depending on differences of optical path lengths in the transparent substrate. In addition, a region in which the plurality of phases of the refractive index variation region are arranged in two rows and two columns is set as a unit grating, and a plurality of the unit gratings are arranged. When light is transmitted through the inside of the refractive index variation region of the diffraction grating portion, the incident light beam is separated and exits by diffraction effect based on phase difference. Furthermore, the diffraction grating portion is formed in the transparent substrate. Thereby, the surface of the transparent substrate is planarized to air space adjacent thereto, and a height and a period of each grating in the diffraction grating portion increase.

According to a second aspect of the invention, two regions arranged in one diagonal direction in each of the plurality of unit gratings have phases of 0 and 2φ, the other two regions arranged in the other diagonal direction in each of the plurality of unit gratings have phases of φ and 3φ, wherein each of the plurality of the unit gratings satisfies the following conditional expression (1):

|mφ−mπ/2|≦(mπ/2)/5 (1), and

wherein m is an integer of 1 to 3.

According to a third aspect of the invention, two regions arranged in one diagonal direction in each of the plurality of unit gratings have phases of 0 and 2φ, the other two regions arranged in the other diagonal direction in each of the plurality of unit gratings have phases of φ and 3φ, wherein each of the plurality of the unit grating satisfies the following conditional expression (2) or (3) and the following conditional expression (4):

|Ψ−a·(aπ/2)|≦a·(aπ/2)/16 (2),

|Ψ−b·(aπ/2)|≦b·(aπ/2)/16 (3),

|2φ−(aπ)|≦(aπ)/16 (4), and

wherein a is equal to 115/90 and b is equal to (2-a).

According to a forth aspect of the invention, the plurality of regions are alternately arranged phases 0 and φ, and wherein each of the plurality of the unit grating satisfies the following conditional expression (5):

|φ−π|≦π/10 (5).

According to a fifth aspect of the invention, the filter satisfies the following conditional expression (6):

H·|N2−N1|=λ/2 (6), and

wherein N1 is a refractive index of the transparent substrate, N2 is a refractive index of the refractive index variation region, H is a height of the grating corresponding to a phase π, and λ is a central wavelength.

According to a sixth aspect of the invention, an imaging apparatus is provided with an imaging device; and a diffraction grating low-pass filter according to claim 1 being disposed on a light receiving surface of the imaging device.

According to the aspect of the invention, a diffraction grating low-pass filter includes: a transparent substrate; and a diffraction grating portion formed in the transparent substrate. The diffraction grating portion has a refractive index variation region having a refractive index different from that of the transparent substrate and including a plurality of phases depending on differences of optical path lengths in the transparent substrate. In addition, a region in which the plurality of phases of the refractive index variation region are arranged in two rows and two columns is set as a unit grating, and a plurality of the unit gratings are arranged. Thus, it is possible to separate a beam without attaching and matching a plurality of optical elements like a low-pass filter using a crystal plate. Accordingly, the filter may be formed thin as compared with the case of the filter using the crystal plate. In addition, it is possible to suppress occurrence of flare and Moire pattern between the imaging device and the filter. Accordingly, it is possible to achieve a decrease in thickness as compared with the case of using a crystal plate and to suppress deterioration in image quality even when using a diffraction grating. Moreover, when the predetermined conditional expressions based on phase values of the diffraction grating are satisfied, it is possible to reduce illumination intensity fluctuation depending on a wavelength.

Other aspects and advantages of the invention will be apparent from the following description and the appended claims.

### BRIEF DESCRIPTION OF THE DRAWINGS

FIG. 1 is a perspective view illustrating a schematic configuration of an OLPF according to a first exemplary embodiment of the invention;

FIG. 2A is a top plan view which shows a diffraction grating in the OLPF according to the first exemplary embodiment of the invention;

FIG. 2B is a perspective view which shows a diffraction grating in the OLPF according to the first exemplary embodiment of the invention.

FIG. 3A is a top plan view which shows a diffraction grating in an OLPF according to a second exemplary embodiment of the invention;

FIG. 3B is a perspective view which shows a diffraction grating in an OLPF according to a second exemplary embodiment of the invention;

FIG. 4A a top plan view which show a diffraction grating in an OLPF according to a third exemplary embodiment of the invention;

FIG. 4B is a perspective view which shows a diffraction grating in an OLPF according to a third exemplary embodiment of the invention;

FIG. 5 shows diffraction efficiencies (a design wavelength of 550 nm) at a wavelength of 550 nm of an OLPF according to Example 1;

FIG. 6 shows diffraction efficiencies (a design wavelength of 550 nm) at a wavelength of 550 nm of the OLPF according to Example 1;

FIG. 7 shows diffraction efficiency sums of respective orders in diffraction efficiencies at a wavelength of 550 nm of the OLPF according to Example 1;

FIG. 8A is a case of a wavelength of 460 nm, which shows diffraction efficiencies at the center of a common difference when a design wavelength of the OLPF according to Example 1 is 530 nm;

FIG. 8B is a case of a wavelength of 550 nm, which shows diffraction efficiencies at the center of a common difference when a design wavelength of the OLPF according to Example 1 is 530 nm;

FIG. 8C is a case of a wavelength of 620 nm, which shows diffraction efficiencies at the center of a common difference when a design wavelength of the OLPF according to Example 1 is 530 nm;

FIG. 8D shows arithmetic averages of the three wavelengths, which shows diffraction efficiencies at the center of a common difference when a design wavelength of the OLPF according to Example 1 is 530 nm;

FIG. 9A is a case of a wavelength of 460 nm, which shows diffraction efficiencies at the center of the common difference when a design wavelength of the OLPF according to Example 1 is 530 nm;

FIG. 9B is a case of a wavelength of 550 nm, which shows diffraction efficiencies at the center of the common difference when a design wavelength of the OLPF according to Example 1 is 530 nm;

FIG. 9C is a case of a wavelength of 620 nm, which shows diffraction efficiencies at the center of the common difference when a design wavelength of the OLPF according to Example 1 is 530 nm;

FIG. 10A is a case of a wavelength of 460 nm, which shows diffraction efficiencies at the negative end of the common difference when a design wavelength of the OLPF according to Example 1 is 530 nm;

FIG. 10B is a case of a wavelength of 550 nm, which shows diffraction efficiencies at the negative end of the common difference when a design wavelength of the OLPF according to Example 1 is 530 nm;

FIG. 10G is a case of a wavelength of 620 nm, which shows diffraction efficiencies at the negative end of the common difference when a design wavelength of the OLPF according to Example 1 is 530 nm;

FIG. 10D shows arithmetic averages of the three wavelengths, which shows diffraction efficiencies at the negative end of the common difference when a design wavelength of the OLPF according to Example 1 is 530 nm;

FIG. 11A a case of a wavelength of 460 nm, which shows diffraction efficiencies at the positive end of the common difference when a design wavelength of the OLPF according to Example 1 is 530 nm;

FIG. 11B is a case of a wavelength of 550 nm, which shows diffraction efficiencies at the positive end of the common difference when a design wavelength of the OLPF according to Example 1 is 530 nm;

FIG. 11C is a case of a wavelength of 620 nm, which shows diffraction efficiencies at the positive end of the common difference when a design wavelength of the OLPF according to Example 1 is 530 nm;

FIG. 11D shows arithmetic averages of the three wavelengths, which shows diffraction efficiencies at the positive end of the common difference when a design wavelength of the OLPF according to Example 1 is 530 nm;

FIG. 12 shows diffraction efficiencies (a design wavelength of 550 nm) at a wavelength of 550 nm of an OLPF according to Example 2;

FIG. 13 shows diffraction efficiencies (a design wavelength of 550 nm) at a wavelength of 550 nm of the OLPF according to Example 2;

FIG. 14 shows diffraction efficiency sums of respective orders in diffraction efficiencies at a wavelength of 550 nm of the OLPF according to Example 2;

FIG. 15A is a case of a wavelength of 460 nm; which shows diffraction efficiencies at the center of a common difference when a design wavelength of the OLPF according to Example 2 is 550 nm;

FIG. 15B is a case of a wavelength of 550 nm, which shows diffraction efficiencies at the center of a common difference when a design wavelength of the OLPF according to Example 2 is 550 nm;

FIG. 15C is a case of a wavelength of 620 nm, which shows diffraction efficiencies at the center of a common difference when a design wavelength of the OLPF according to Example 2 is 550 nm;

FIG. 15D shows arithmetic averages of the three wavelengths, which shows diffraction efficiencies at the center of a common difference when a design wavelength of the OLPF according to Example 2 is 550 nm;

FIG. 16A is a case of a wavelength of 460 nm, which shows diffraction efficiencies at the center of the common difference when a design wavelength of the OLPF according to Example 2 is 550 nm;

FIG. 16B is a case of a wavelength of 550 nm, which shows diffraction efficiencies at the center of the common difference when a design wavelength of the OLPF according to Example 2 is 550 nm;

FIG. 16C is a case of a wavelength of 620 nm, which shows diffraction efficiencies at the center of the common difference when a design wavelength of the OLPF according to Example 2 is 550 nm;

FIG. 17A is a case of a wavelength of 460 nm, which show diffraction efficiencies at the negative end of the common difference when a design wavelength of the OLPF according to Example 2 is 610 nm;

FIG. 17B is a case of a wavelength of 550 nm, which show diffraction efficiencies at the negative end of the common difference when a design wavelength of the OLPF according to Example 2 is 610 nm;

FIG. 17C is a case of a wavelength of 620 nm, which show diffraction efficiencies at the negative end of the common difference when a design wavelength of the OLPF according to Example 2 is 610 nm;

FIG. 17D shows arithmetic averages of the three wavelengths, which show diffraction efficiencies at the negative end of the common difference when a design wavelength of the OLPF according to Example 2 is 610 nm;

FIG. 18A is a case of a wavelength of 460 nm, which shows diffraction efficiencies at the center of the common difference when a design wavelength of the OLPF according to Example 2 is 610 nm;

FIG. 18B is a case of a wavelength of 550 nm, which shows diffraction efficiencies at the center of the common difference when a design wavelength of the OLPF according to Example 2 is 610 nm;

FIG. 18C is a case of a wavelength of 620 nm which shows diffraction efficiencies at the center of the common difference when a design wavelength of the OLPF according to Example 2 is 610 nm;

FIG. 19A is a case of a wavelength of 460 nm, which shows diffraction efficiencies at the negative end of the common difference when a design wavelength of the OLPF according to Example 2 is 610 nm;

FIG. 19B is a case of a wavelength of 550 nm, which shows diffraction efficiencies at the negative end of the common difference when a design wavelength of the OLPF according to Example 2 is 610 nm;

FIG. 19C is a case of a wavelength of 620 nm, which shows diffraction efficiencies at the negative end of the common difference when a design wavelength of the OLPF according to Example 2 is 610 nm;

FIG. 19D shows arithmetic averages of the three wavelengths, which shows diffraction efficiencies at the negative end of the common difference when a design wavelength of the OLPF according to Example 2 is 610 nm;

FIG. 20A is a case of a wavelength of 460 nm, which shows diffraction efficiencies at the positive end of the common difference when a design wavelength of the OLPF according to Example 2 is 610 nm;

FIG. 20B is a case of a wavelength of 550 nm, which shows diffraction efficiencies at the positive end of the common difference when a design wavelength of the OLPF according to Example 2 is 610 nm;

FIG. 20C is a case of a wavelength of 620 nm, which shows diffraction efficiencies at the positive end of the common difference when a design wavelength of the OLPF according to Example 2 is 610 nm;

FIG. 20D shows arithmetic averages of the three wavelengths; which shows diffraction efficiencies at the positive end of the common difference when a design wavelength of the OLPF according to Example 2 is 610 nm;

FIG. 21 shows diffraction efficiencies (a design wavelength of 550 nm) at a wavelength of 550 nm of an OLPF according to Example 3;

FIG. 22 shows diffraction efficiencies (a design wavelength of 550 nm) at a wavelength of 550 nm of the OLPF according to Example 3;

FIG. 23 shows diffraction efficiency sums of respective orders in diffraction efficiencies at a wavelength of 550 nm of the OLPF according to Example 3;

FIG. 24A a case of a wavelength of 460 nm, which shows diffraction efficiencies at the center of a common difference when a design wavelength of the OLPF according to Example 3 is 550 nm;

FIG. 24B is a case of a wavelength of 550 nm, which shows diffraction efficiencies at the center of a common difference when a design wavelength of the OLPF according to Example 3 is 550 nm;

FIG. 24C is a case of a wavelength of 620 nm, which shows diffraction efficiencies at the center of a common difference when a design wavelength of the OLPF according to Example 3 is 550 nm;

FIG. 24D shows arithmetic averages of the three wavelengths, which shows diffraction efficiencies at the center of a common difference when a design wavelength of the OLPF according to Example 3 is 550 nm;

FIG. 25A is a case of a wavelength of 460 nm, which shows diffraction efficiencies at the center of the common difference when a design wavelength of the OLPF according to Example 3 is 550 nm;

FIG. 25B is a case of a wavelength of 550 nm, which shows diffraction efficiencies at the center of the common difference when a design wavelength of the OLPF according to Example 3 is 550 nm;

FIG. 25C is a case of a wavelength of 620 nm, which shows diffraction efficiencies at the center of the common difference when a design wavelength of the OLPF according to Example 3 is 550 nm;

FIG. 26A is a case of a wavelength of 460 nm, which shows diffraction efficiencies at the negative end of the common difference when a design wavelength of the OLPF according to Example 3 is 520 nm;

FIG. 26B is a case of a wavelength of 550 nm, which shows diffraction efficiencies at the negative end of the common difference when a design wavelength of the OLPF according to Example 3 is 520 nm;

FIG. 260 is a case of a wavelength of 620 nm which shows diffraction efficiencies at the negative end of the common difference when a design wavelength of the OLPF according to Example 3 is 520 nm;

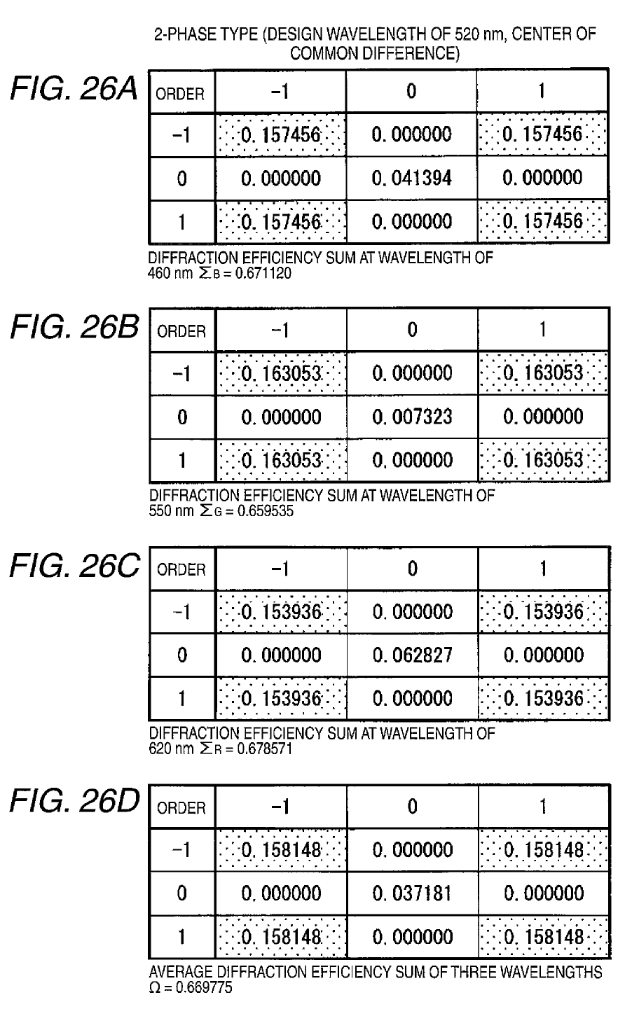

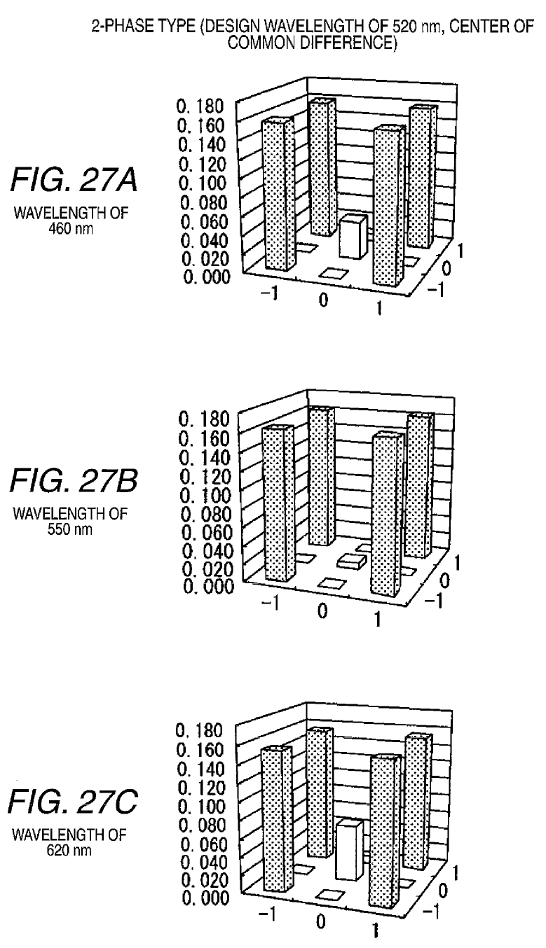

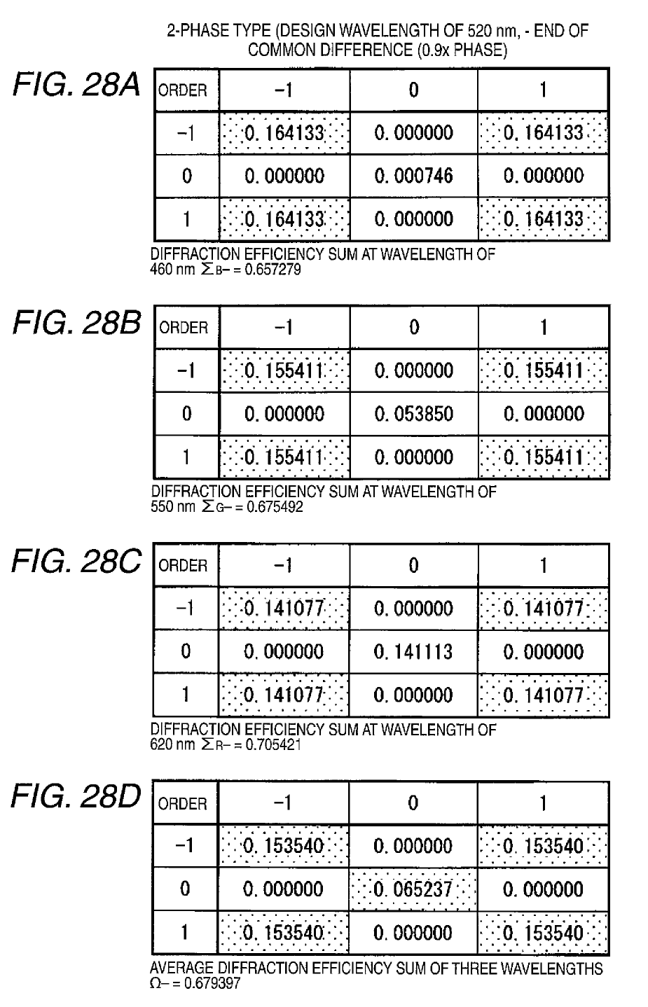

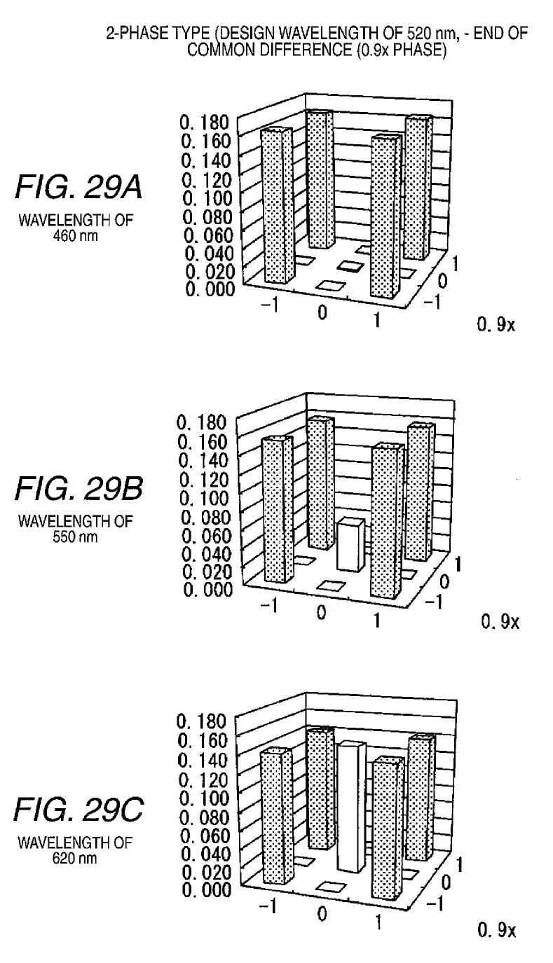

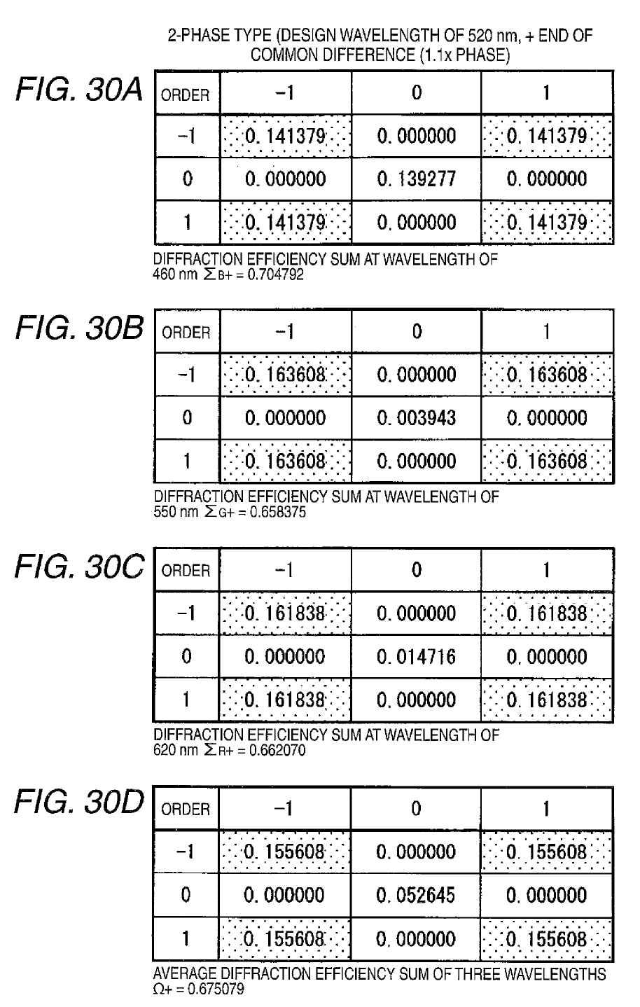

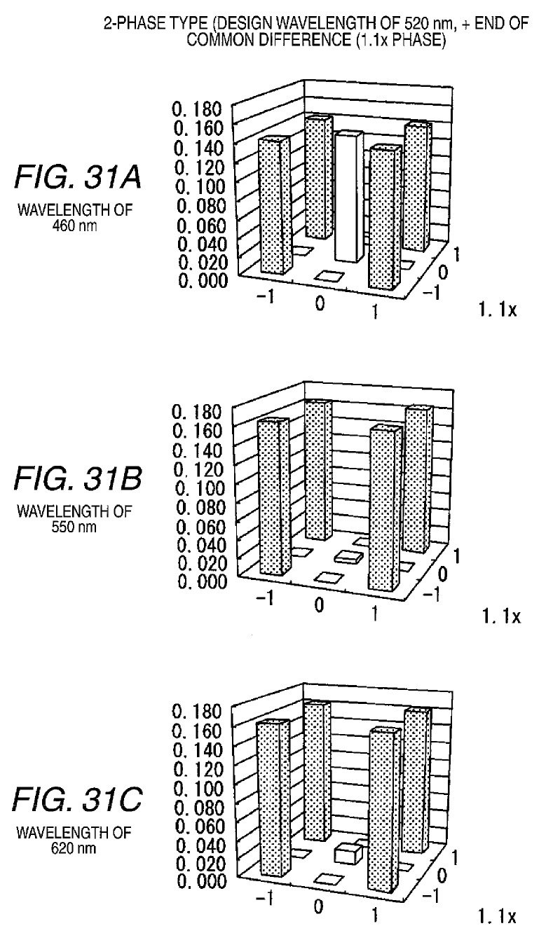

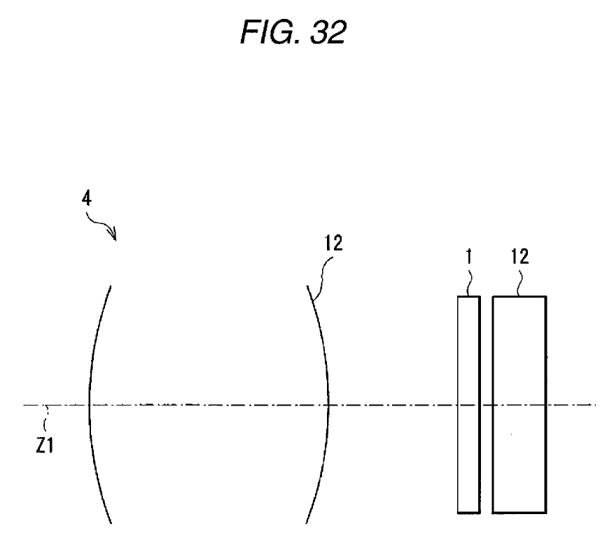

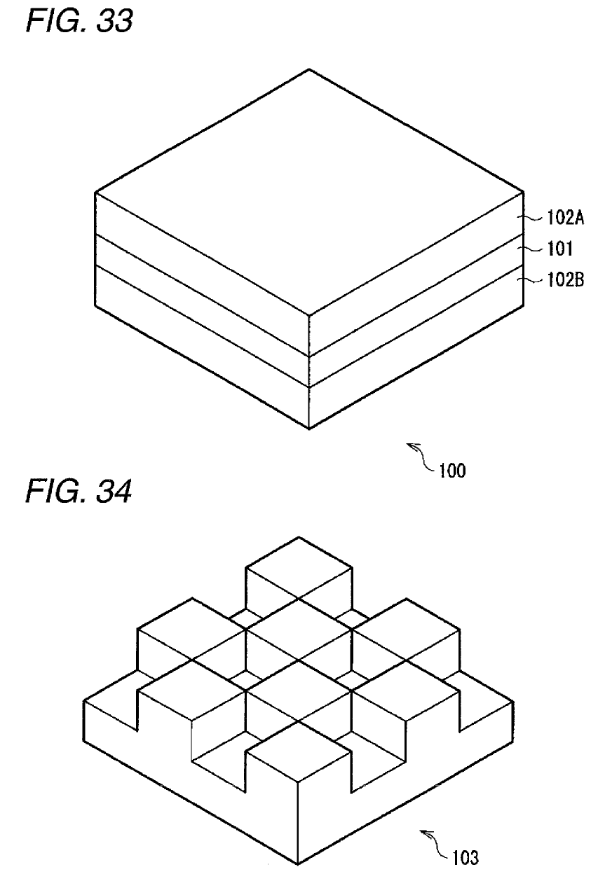

FIG. 26D shows arithmetic averages of the three wavelengths, which shows diffraction efficiencies at the negative end of the common difference when a design wavelength of the OLPF according to Example 3 is 520 nm;

FIG. 27A is a case of a wavelength of 460 nm, which shows diffraction efficiencies at the center of the common difference when a design wavelength of the OLPF according to Example 3 is 520 nm;

FIG. 27B is a case of a wavelength of 550 nm, which shows diffraction efficiencies at the center of the common difference when a design wavelength of the OLPF according to Example 3 is 520 nm;

FIG. 27C is a case of a wavelength of 620 nm, which shows diffraction efficiencies at the center of the common difference when a design wavelength of the OLPF according to Example 3 is 520 nm;

FIG. 28A a case of a wavelength of 460 nm, which shows diffraction efficiencies at the negative end of the common difference when a design wavelength of the OLPF according to Example 3 is 520 nm;

FIG. 28B is a case of a wavelength of 550 nm, which shows diffraction efficiencies at the negative end of the common difference when a design wavelength of the OLPF according to Example 3 is 520 nm;

FIG. 28C is a case of a wavelength of 620 nm, which shows diffraction efficiencies at the negative end of the common difference when a design wavelength of the OLPF according to Example 3 is 520 nm;

FIG. 28D shows arithmetic averages of the three wavelengths, which shows diffraction efficiencies at the negative end of the common difference when a design wavelength of the OLPF according to Example 3 is 520 nm;

FIG. 29A is a case of a wavelength of 460 nm, which shows diffraction efficiencies at the negative end of the common difference when a design wavelength of the OLPF according to Example 3 is 520 nm;

FIG. 29B is a case of a wavelength of 550 nm, which shows diffraction efficiencies at the negative end of the common difference when a design wavelength of the OLPF according to Example 3 is 520 nm;

FIG. 29C is a case of a wavelength of 620 nm, which shows diffraction efficiencies at the negative end of the common difference when a design wavelength of the OLPF according to Example 3 is 520 nm;

FIG. 30A is a case of a wavelength of 460 nm, which shows diffraction efficiencies at the positive end of the common difference when a design wavelength of the OLPF according to Example 3 is 520 nm;

FIG. 30B is a case of a wavelength of 550 nm, which shows diffraction efficiencies at the positive end of the common difference when a design wavelength of the OLPF according to Example 3 is 520 nm;

FIG. 30C is a case of a wavelength of 620 nm, which shows diffraction efficiencies at the positive end of the common difference when a design wavelength of the OLPF according to Example 3 is 520 nm;

FIG. 30D shows arithmetic averages of the three wavelengths, which shows diffraction efficiencies at the positive end of the common difference when a design wavelength of the OLPF according to Example 3 is 520 nm;

FIG. 31A is a case of a wavelength of 460 nm, which shows diffraction efficiencies at the positive end of the common difference when a design wavelength of the OLPF according to Example 3 is 520 nm;

FIG. 31B is a case of a wavelength of 550 nm, which shows diffraction efficiencies at the positive end of the common difference when a design wavelength of the OLPF according to Example 3 is 520 nm;

FIG. 31C is a case of a wavelength of 620 nm, which shows diffraction efficiencies at the positive end of the common difference when a design wavelength of the OLPF according to Example 3 is 520 nm;

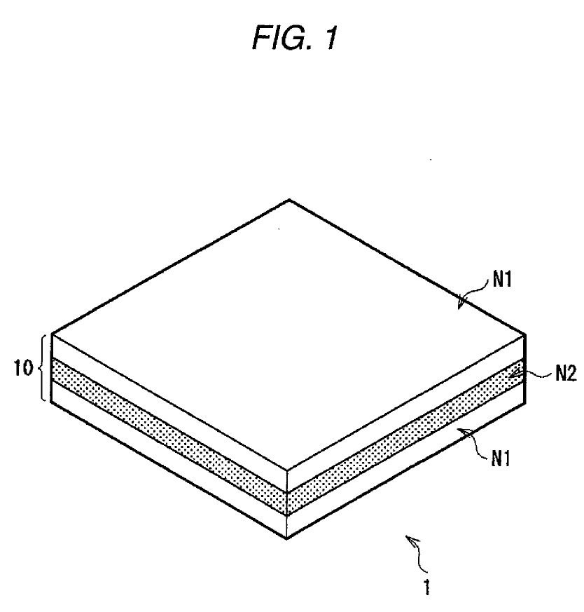

FIG. 32 shows an example of an imaging apparatus using the diffraction grating low-pass filter shown in FIG. 1;

FIG. 33 is a perspective view illustrating an OLPF using a crystal plate according to a known example; and

FIG. 34 is a perspective view illustrating a schematic configuration of a diffraction grating type OLPF according to the known example.

### DESCRIPTION OF EXEMPLARY EMBODIMENTS

Hereinafter, exemplary embodiments of the present invention will be described in detail with reference to the drawings.

### First Exemplary Embodiment

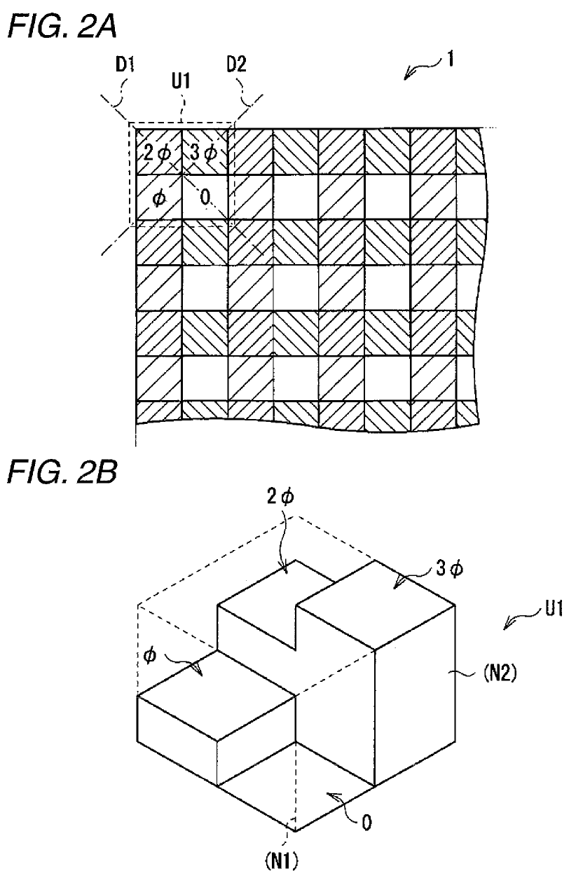

FIG. 1 is a perspective view illustrating a schematic configuration of a diffraction grating low-pass filter 1 according to a first exemplary embodiment of the present invention. FIGS. 2A and 2B are schematic views illustrating a diffraction grating (a diffraction grating portion) formed in the diffraction grating low-pass filter 1, where FIG. 2A is a top plan view and FIG. 2B is a perspective view of a unit grating portion. The diffraction grating low-pass filter 1 is disposed on an imaging surface (a light receiving surface) of a solid-state imaging device 12 such as CCD or CMOS in an imaging apparatus 4 as shown in FIG. 32. Examples of the imaging apparatus include a digital still camera, a portable cellular phone having a camera mounted thereon, and a portable information terminal. The diffraction grating low-pass filter separates an incident light beam emitted from an optical imaging system 11 to suppress occurrence of undesirable colors and Moire pattern caused by high frequency components included in a subject.

The diffraction grating low-pass filter 1 includes a transparent substrate, that is, an optical glass substrate (which is hereinafter referred to as a glass substrate simply) such as a quartz substrate. In the glass substrate 10, a diffraction grating in which a plurality of minute regions having the same shape is arranged in a lattice shape is formed. Specifically, the diffraction grating is formed of refractive index variation regions (regions having a refractive index N2 in FIG. 1) having a refractive index different from a refractive index N1 of the glass substrate 10. In each refractive index variation region, plural phases are formed by differences of optical path lengths.

For example, as shown in FIGS. 2A and 2B, in the refractive index variation region of the diffraction grating, a plurality of unit gratings U1 are arranged. Each unit grating U1 is a region having an array of two rows and two columns in which regions of phases 0 and 2φ are arranged in one diagonal direction D1 and regions of phases φ and 3φ are arranged in the other diagonal direction D2. Specifically, the diffraction grating low-pass filter 1 is formed as a diffraction grating low-pass filter having four phase values.

The diffraction grating may be formed by being irradiated with a focused pulse laser beam. Specifically, a laser beam is focused on a desired position in the glass substrate 10, a laser intensity of the beam is appropriately adjusted, and the laser beam is irradiated thereon. Thereby, it is possible to form the pattern mentioned above by performing lithography.

The diffraction grating low-pass filter 1 having four phase values satisfies the following conditional expression (1). Here, m is assumed as any one of integers of 1 to 3. In addition, it is assumed that increase and decrease directions, that is, algebraic signs of a variation common difference (which is hereinafter referred to as a common difference simply) between phases in the unit grating U1 are the same.

|mφ−mπ/2|≦(mπ/2)/5 (1)

Furthermore, in the diffraction grating low-pass filter 1, for example, when 0th-order diffracted light which travels straightly is not necessary, the filter is configured to satisfy the following conditional expression (6). Here, it is assumed that a refractive index of the glass substrate 10 is N1, a refractive index of the refractive index variation region is N2, a height of the grating corresponding to a phase π is H, and a central wavelength is λ.

H·|N2−N1|=λ/2 (6)

Next, operations and effects of the diffraction grating low-pass filter 1 such the constitution above will be described.

The diffraction grating low-pass filter 1 has the diffraction grating in which a refractive index variation region having a refractive index different from that of the glass substrate 10 and including a plurality of phases depending on differences of optical path lengths is formed in the glass substrate 10. Thus, when light is transmitted through the inside of the refractive index variation region of the diffraction grating portion, the incident light beam is separated and exits by diffraction effect based on phase difference. Thereby, it is possible to suppress occurrence of undesirable colors and Moire pattern caused by high frequency components included in a subject.

In this case, assuming that grating period of the diffraction grating is P, diffraction order is m, and a distance between the diffraction grating and the imaging surface of the imaging device is f, an expression of diffraction is represented by sin θ=mλ/P, where θ is a diffraction angle and m is a positive integer. In addition, a beam separation width d is represented by d=f·tan θ≅f·sin θ=mλf/P. That is, the beam separation width d is directly proportional to a wavelength λ. Furthermore, a Nyquist frequency of the OLPF is set as 1.0 and MTF (Modulation Transfer Function) is set as 0. Thereby, a beam separation width d is made equal to one pitch width of an imaging pixel.

Here, in the diffraction grating low-pass filter 103 shown in FIG. 34, the surface (which is disposed to face toward the imaging device) has a concavo-convex shape, and a grating-shaped region is disposed by the concavo-convex shape. In this case, the height of the grating is an order of a wavelength, and thus a grating period decreases by about ten times the wavelength in response thereto. In addition, when the grating period P is small, the distance f should be set small in response thereto. Hence, the concavo-convex shape is formed on a position close to the imaging surface, for example, a position distant 0.05 mm from the light receiving surface of the imaging surface. Thus, a fringe pattern, that is, a so-called Moire pattern is caused by positional deviation between a grating period of imaging pixels arranged in a lattice shape and a grating period of a concavo-convex shape, thereby deteriorating image quality. In addition, such occurrence of Moire pattern may be suppressed by rotating or diagonally disposing a rectangular matrix shaped grating surface, but production process becomes complicated.

In addition, as described above, in the rear surface of the diffraction grating low-pass filter 103, when a height and a period of the grating thereof is small and a diffraction angle thereof is large, an angle of total reflection thereof is likely to coincide with the diffraction angle thereof. Hence, sometimes, a beam transmitted through the diffraction grating low-pass filter 103 is fully reflected by the imaging surface of the imaging device, and subsequently may enter the imaging device again. Accordingly, a so-called flare occurs, and it becomes a factor of deterioration in image quality.

Hence, in the exemplary embodiment, the diffraction grating portion for diffraction effect is formed in the glass substrate 10. With such a configuration, the surface of (the surface of the glass substrate 10) the diffraction grating low-pass filter 1 is planarized. Furthermore, assuming that a refractive index difference in the unit grating U1 is ΔN=|N2−N1, a height H of the grating may be represented by H=(λ/2)/ΔN. In this case, a refractive index difference ΔN becomes about one tenth or less of a refractive index difference (which is a refractive index difference between air and the substrate and is represented by the Δn 32 N−1) in the case of the known concavo-convex shape as shown in FIG. 34. Accordingly, the height H of the grating becomes about ten times or more that of the concavo-convex shape. Thus, considering an aspect ratio, a diffraction efficiency of inclined incidence, and the like, a grating period P becomes about ten times or more in response thereto. Hence, the diffraction angle θ and the beam separation width d inversely proportional to the grating period P become about one tenth of those of the concavo-convex shape. Thus, assuming that one pixel pitch is the beam separation width d, a distance f between the imaging surface and the low-pass filter becomes about ten times or more. Specifically, it is possible to dispose the diffraction grating low-pass filter 1 on a position sufficiently far from the imaging surface of the imaging device. For example, the position may be distanced at 0.5 mm to 1.0 mm therefrom.

Accordingly, as a height and a period of the grating increases, it is possible to dispose the filter on the position sufficiently far from the imaging surface of the imaging device. With such a configuration, it is possible to suppress occurrence of Moire pattern caused by deviation between grating periods of the imaging device and the diffraction grating. In addition, occurrence of Moire pattern may be also suppressed by planarizing the surface of the diffraction grating low-pass filter 1.

Furthermore, since a height H and a period P of the grating are large and a diffraction angle θ is small, total reflection of light beams is suppressed in the front and rear surfaces of the diffraction grating low-pass filter 1. Specifically, as viewed from the outside, the filter is equivalent to a plane parallel plate formed by performing antireflective coating on both surfaces of a glass substrate thereof. With such a configuration, it is possible to suppress occurrence of flare as described above.

Next, the conditional expression (1) will be described. The conditional expression (1) defines an optimized range of a common difference of phases in the unit grating U1 depending on wavelength variation, in a diffraction grating having four phase values. By satisfying the conditional expression (1), variance, that is, variation of diffraction efficiency depending on wavelength variation is reduced. Thereby, it is possible to reduce illumination intensity fluctuation depending on wavelength variation, and it is also possible to improve color balance of an obtained image. The conditional expression (1) is derived as follows.

As a factor of the illumination intensity fluctuation depending on wavelength variation, deviation of a beam separation width d depending on a wavelength or variance of diffraction efficiency depending on a wavelength is considered. First, a method of improving deviation of the beam separation width d will be described. As described above, a Nyquist frequency of the OLPF is set as 1.0 and MTF (Modulation Transfer Function) is set as 0. Thereby, a beam separation width d is made equal to one pitch width of an imaging pixel. Specifically, deviation of the beam separation width d depending on a wavelength is deviation of one pixel pitch, and is deviation of a Nyquist frequency depending on a wavelength. In this case, since a beam separation width d of a short wavelength is relatively small, a Nyquist frequency is shifted to a high frequency side. However, since refractive index variation of the optical glass of the short wavelength side is larger than that of the long wavelength side, a MTF of the short wavelength side becomes easily lower than a MTF of the long wavelength side. Thus, practically, the problem is not so severe. In addition, in a diffraction grating having a relatively simple structure, it is difficult in principle to improve deviation of the beam separation width d depending on the wavelength.

Next, a method of reducing variance of the diffraction efficiency depending on the wavelength variation will be described. Here, the diffraction efficiency of the diffraction grating is defined as an energy efficiency of the light traveling in a direction of a diffraction angle θ in accordance with a diffraction order. Thus, the diffraction efficiency is regarded as variance of energy efficiency depending on a wavelength. In addition, when illumination intensity is uniform on the imaging surface, a ratio of variance in sensitivity of the imaging pixel is called photo response non-uniformity (PRNU). For example, there are criteria that a root mean square (RMS) of variance of an output voltage should be within 1%, a P-V (peak to valley) value should be within 3%, and so on. In addition, there is also a criterion that variance of brightness of a monitor should be within 2%, but it means variance of brightness of parts of the monitor or variance of sensitivity of the imaging pixels. In the exemplary embodiment of the present invention, it is assumed that the whole imaging surface has uniform sensitivity and incident light is non-uniform in energy distribution.

For example, in CCD cameras, three primary colors such as B (blue), G (Green), and R (Red) are used. Thus, in the optical design, mostly used wavelengths representative of B-ch, G-ch and R-ch are 460 nm, 550 nm (or e-line), and 620 nm, respectively. Accordingly, optimization of the common difference range is performed on light having the three wavelength regions of 460 nm, 550 nm, and 620 nm.

Specifically, regarding a variation common difference of four phases (that is, a height of the grating) of the unit grating U1, it is desired that an average diffraction efficiency of the three wavelengths at the ± (positive and negative) ends of the common difference is suppressed within variance of ±1.5% with respect to an average diffraction efficiency of the three wavelengths at the center of the common difference. It is preferred that an average diffraction efficiency of the three wavelengths at the center of the common difference be about 1.3%. In addition, it is assumed that transmittances of the three wavelengths has no difference before the light having the wavelengths reaches a three color separation filter (color filter) or the imaging surface and an average diffraction efficiency is an arithmetic average of the three wavelengths.

In this case, in terms of the diffraction efficiency, energy is highly concentrated on −1st to +1st order diffracted light beams among whole diffracted light beams. From this, it would appear that as summation Σ of diffraction efficiencies of the diffracted light beams having these orders (±1, ±1) increases, energy flow to second or more order diffracted light, that is, high order diffracted light decreases. Accordingly, each diffraction efficiency sum Σ of −1st to +1st orders of each of three wavelengths at the center of the common difference and the ± ends of the common difference is calculated. Thereby, an arithmetic average diffraction efficiency Ω of three wavelengths of diffraction efficiency sums Σ of −1st to +1st orders at the center of the common difference and the ± ends of the common difference is calculated.

When a grating design wavelength is set by, for example, 550 nm, the wavelength is properly shifted frontward or backward from the wavelength of 550 nm, and thus the common difference range is optimized to satisfy the desired variance of 1.5%. As described above, the conditional expression (1) is derived.

Next, the conditional expression (6) will be described. The conditional expression (6) defines a phase difference and an optical path length difference. By satisfying the conditional expression (6), 0th order diffracted light is eliminated by light interference effect. To eliminate the 0th order diffracted light, it is preferred that a phase difference between regions adjacent to each other in a row direction, a column direction, or a diagonal direction in the unit grating U1 be π. That is, it is preferred that an optical path length difference be a half wavelength (=λ/2). Accordingly, the expression (7) is represented as follows, and the conditional expression (6) is derived by modifying the expression (7).

Optical path length difference=|H·N2·H·N1|=λ/2 (7)

As described above, in the diffraction grating low-pass filter 1, the diffraction grating portion has a refractive index variation region having a refractive index different from that of the glass substrate 10 and including a plurality of phases depending on differences of optical path lengths in the glass substrate 10. With such a configuration, phase difference is caused by light traveling through the refractive index variation region. Thus, it is possible to separate an incident light beam while suppressing occurrence of Moire pattern and flare between the imaging apparatus and the filter by diffraction effect based on the phase difference. In addition, by satisfying the conditional expression on (1) the basis of the four phase values of the diffraction grating, it is possible to reduce illumination intensity fluctuation depending on a wavelength of the incident light.

Furthermore, as compared with the OLPF 100 according to the known example shown in FIG. 33, it is possible to decrease a thickness thereof. Generally, in the case of a crystal plate, the incident beam is separated into two beams of a normal beam and an abnormal beam by birefringence property of crystal. Hence, to separate the beam into four beams, it is necessary that a retardation plate 101 for converting polarized light into circularly polarized light is configured to be interposed between two crystal plates 102A and 102B, an incident beam is separated into two beams by the crystal plate on an incident side, subsequently the two beams are circularly polarized by the retardation plate, and each of the circularly polarized two beams is separated into two beams again by the crystal plate on an exit side. Because of this, the OLPF 100 has a thickness of a plate formed of three optical elements, and thus a thickness thereof in an optical axis direction increases by about 3 mm to 5 mm. To solve this problem, the diffraction grating low-pass filter 1 according to the exemplary embodiment is configured to have one optical substrate in which a diffraction grating is lithographed. Thus, the filter may be formed as a plane parallel plate having a thickness of about 0.5 mm or less. In optical systems of small imaging devices, a space between the outermost surfaces of an optical lens system and an imaging device, that is, a back focus length is not sufficient. Thus, this configuration mentioned above is advantageous in optical design. With such a configuration, it is possible to achieve a decrease in thickness as compared with the case of using a crystal plate and suppress deterioration in image quality even when using a diffraction grating.

Furthermore, by appropriately setting design parameters, the filter is able to perform a function as a plane parallel plate (a cover glass) which is disposed on a position distant 0.5 mm from the front side of the imaging surface to prevent dust.

### Second Exemplary Embodiment

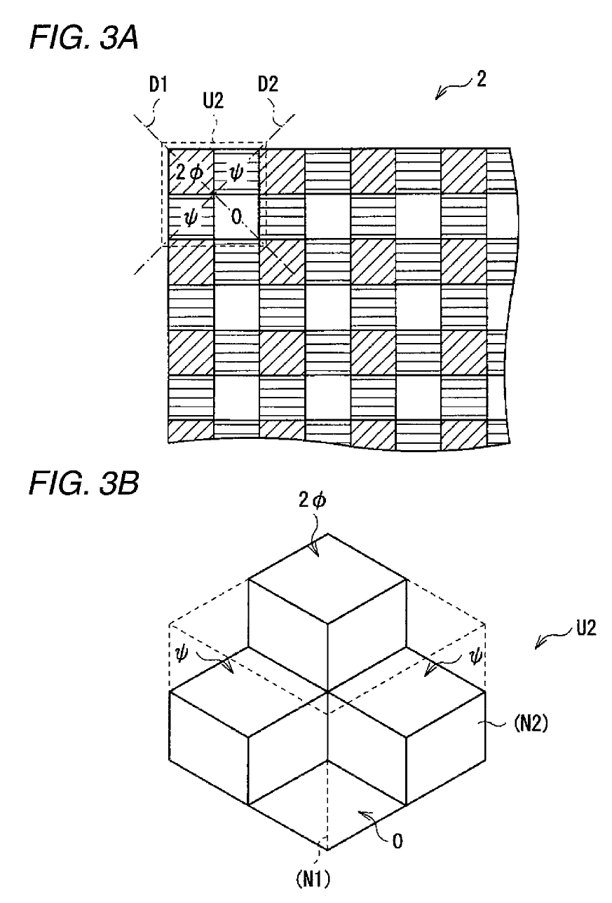

FIGS. 3A and 3B are schematic views illustrating a diffraction grating (a diffraction grating portion) formed in the diffraction grating low-pass filter 2 according to a second exemplary embodiment, where FIG. 3A is a top plan view and FIG. 3B is a perspective view of a unit grating portion. The diffraction grating low-pass filter 2 is configured similarly to the first exemplary embodiment except for the arrangement of the diffraction grating formed in the glass substrate 10. Accordingly, description of the same configuration as the first exemplary embodiment will be properly omitted.

Similarly to the diffraction grating low-pass filter 1 according to the first exemplary embodiment, in the diffraction grating low-pass filter 2, there is provided a diffraction grating including a refractive index variation region having a plurality of phases in the glass substrate 10. Here, the unit grating U2 of the diffraction grating is formed as a grating having an array of two rows and two columns in which regions of phases 0 and 2φ are arranged in one diagonal direction D1 and regions of phases Ψ and Ψ are arranged in the other diagonal direction D2. Specifically, the diffraction grating low-pass filter 2 is formed as a diffraction grating low-pass filter having three phase values.

he diffraction grating low-pass filter 2 having three phase values satisfies the following conditional expression (2) or (3) and the following conditional expression (4). Here, m is assumed as any one of integers of 1 to 3. In addition, it is assumed that increase and decrease directions, that is, algebraic signs of a common difference between phases in the unit grating U2 are the same. Furthermore, similarly to the conditional expression (1) according to the first exemplary embodiment, the conditional expressions (2) to (4) are derived by performing optimization of a common difference range based on values of the three phases of the diffraction grating on light having three wavelengths.

|Ψ−a·(aπ/2)|≦a·(aπ/2)/16 (2)

|Ψ−b·(aπ/2)|≦b·(aπ/2)/16 (3)

|2100 −(aπ)|≦(aπ)/16 (4)

Furthermore, in the diffraction grating low-pass filter 2, for example, when 0th-order diffracted light which travels straightly is not necessary, the filter may satisfy the following conditional expression (6).

According to the diffraction grating low-pass filter 2 configured as described above, the diffraction grating is disposed in the glass substrate 10. Thus, similarly to the first exemplary embodiment, it is possible to achieve a decrease in thickness as compared with the case of using a crystal plate. In addition, it is possible to suppress occurrence of Moire pattern and flare between the filter and the imaging device. Moreover, by satisfying the conditional expression (2) or (3) and the conditional expression (4) on the basis of the three phase values of the diffraction grating, it is possible to reduce illumination intensity fluctuation depending on a wavelength of the incident light.

### Third Exemplary Embodiment

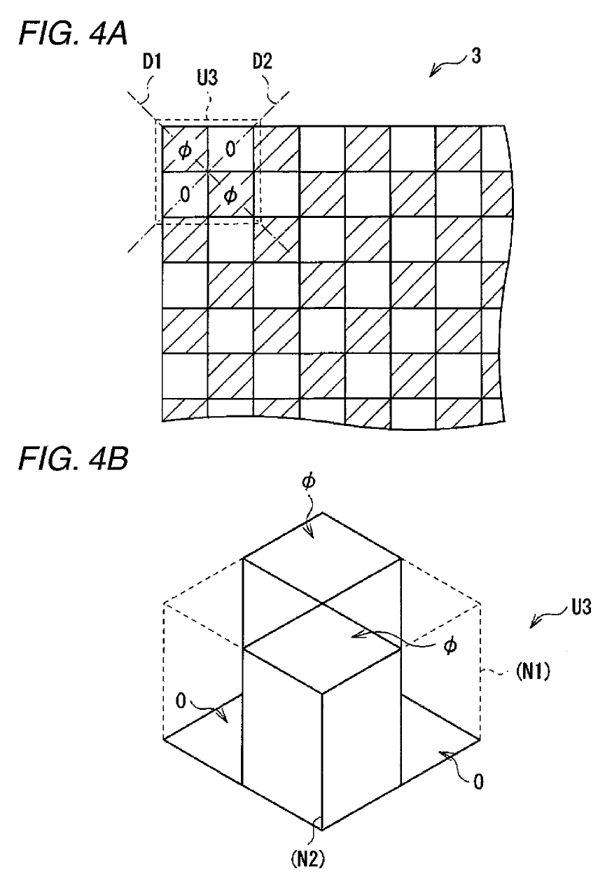

FIGS. 4A and 4B are schematic views illustrating a diffraction grating (a diffraction grating portion) formed in the diffraction grating low-pass filter 3 according to a third exemplary embodiment, where FIG. 4A is a top plan view and FIG. 4B is a perspective view of a unit grating portion. The diffraction grating low-pass filter 3 is configured similarly to the first exemplary embodiment except for the arrangement of the diffraction grating formed in the glass substrate 10. Accordingly, description of the same configuration as the first exemplary embodiment will be properly omitted.

Similarly to the diffraction grating low-pass filter 1 according to the first exemplary embodiment, in the diffraction grating low-pass filter 3, there is provided a diffraction grating including a refractive index variation region having a plurality of phases in the glass substrate 10. Here, the unit grating U3 of the diffraction grating is formed as a grating having an array of two rows and two columns in which regions of phases φ and φ are arranged in one diagonal direction D1 and regions of phases 0 and 0 are arranged in the other diagonal direction D2. Specifically, the diffraction grating low-pass filter 3 is formed as a diffraction grating low-pass filter having two phase values.

The diffraction grating low-pass filter 3 having two phase values satisfies the following conditional expression (5). Here, m is assumed as any one of integers of 1 to 3. In addition, it is assumed that increase and decrease directions, that is, algebraic signs of a common difference between phases in the unit grating U3 are the same. Furthermore, similarly to the conditional expression (1) according to the first exemplary embodiment, the conditional expression (5) is derived by performing optimization of a common difference range based on values of the two phases of the diffraction grating on light having three wavelengths.

|φ−π|≦π/10 (5)

Furthermore, in the diffraction grating low-pass filter 3, for example, when 0th-order diffracted light which travels straightly is not necessary, the filter may satisfy the following conditional expression (6).

According to the diffraction grating low-pass filter 3 configured as described above, the diffraction grating is disposed in the glass substrate 10. Thus, similarly to the first exemplary embodiment, it is possible to achieve a decrease in thickness as compared with the case of using a crystal plate. In addition, it is possible to suppress occurrence of Moire pattern and flare between the filter and the imaging device. Moreover, by satisfying the conditional expression (5) on the basis of the two phase values of the diffraction grating, it is possible to reduce illumination intensity fluctuation depending on a wavelength of the incident light.

### EXAMPLES

Next, specific numerical value examples of the OLPF according to the exemplary embodiment will be described.

### Example 1

In Example 1, when the diffraction grating low-pass filter 1 having four phase values (0, φ, 2φ, and 3φ) according to the first exemplary embodiment is used, variance of the diffraction efficiency at three wavelengths of B (a wavelength of 460 nm), G (a wavelength of 550 nm), and R (a wavelength of 620 nm) is estimated. Specifically, first, in a design of a design wavelength of 550 nm and a phase φ=π/2 as a desired example, a diffraction efficiency at a wavelength of 550 nm (φ=π/2) is measured. Next, the design wavelength is shifted to 530 nm, and diffraction efficiency sums Σ_{B}, Σ_{G}, and Σ_{R} are calculated from diffraction efficiencies of a wavelength of 460 nm, a wavelength of 550 nm, and a wavelength of 620 nm at the center of the common difference. Thereby, an average diffraction efficiency sum Ω of the three wavelengths is calculated. In addition, an average diffraction efficiency sum Ω₋ of the three wavelengths is calculated from diffraction efficiency sums Σ_{B-}, Σ_{G-}, and Σ_{R-} of the wavelengths (at negative end of the common difference) when 0.8 times the phase (φ=π/2) is applied to the desired example, at the design wavelength of 530 nm. Likewise, an average diffraction efficiency sum Ω₊ of the three wavelengths is calculated from diffraction efficiency sums Σ_{B+}, Σ_{G+}, and Σ_{E+} of the wavelengths (at positive end of the common difference) when 1.2 times the phase (φ=π/2) is applied to the desired example.

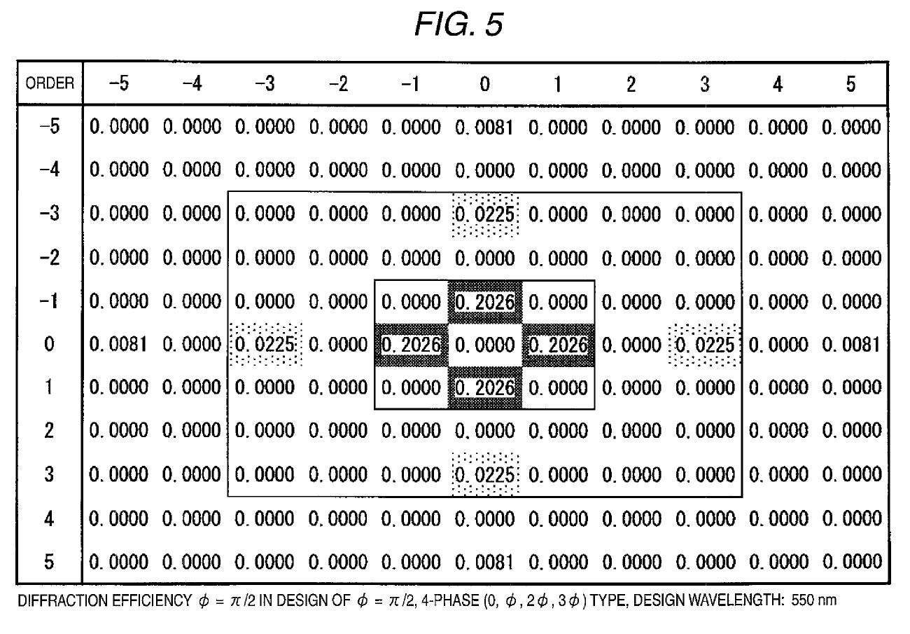

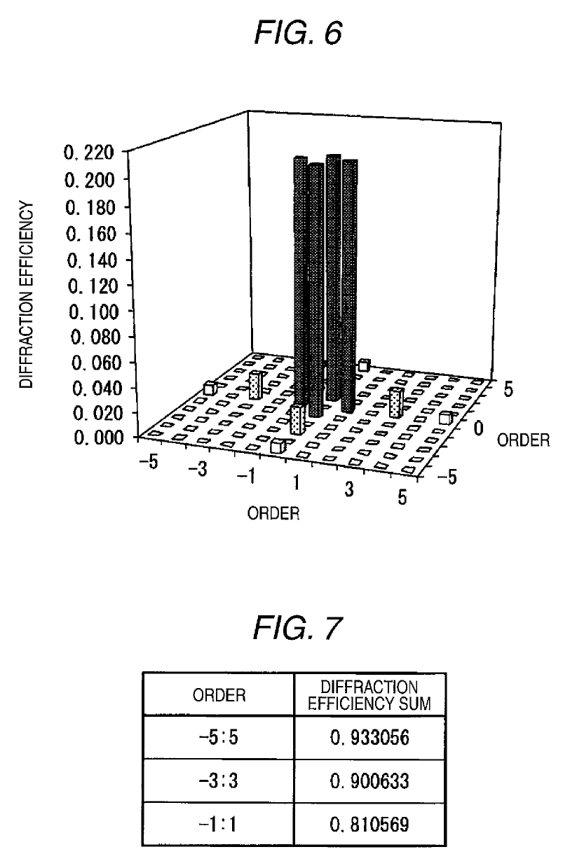

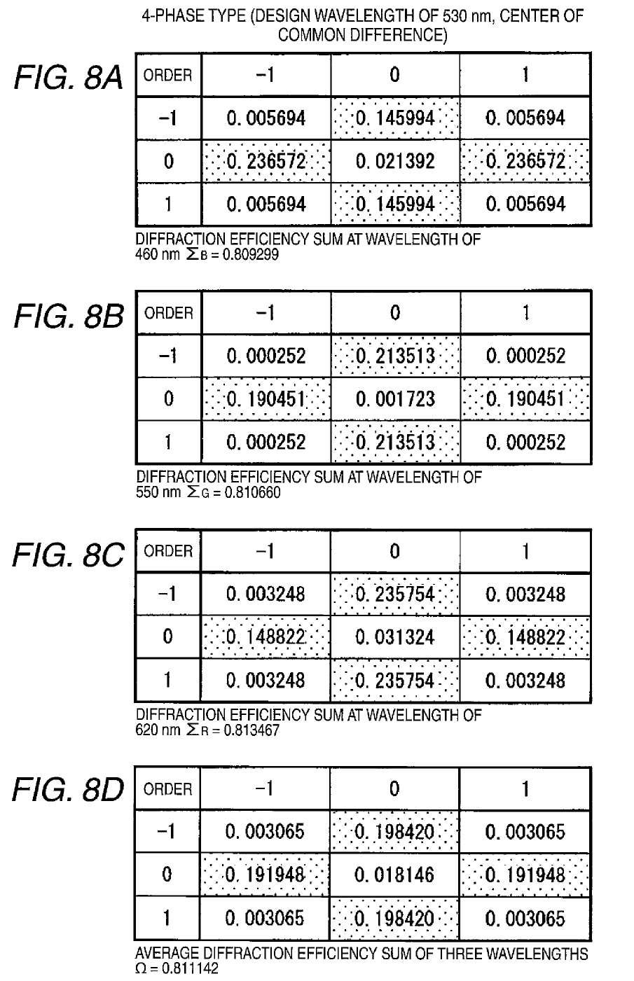

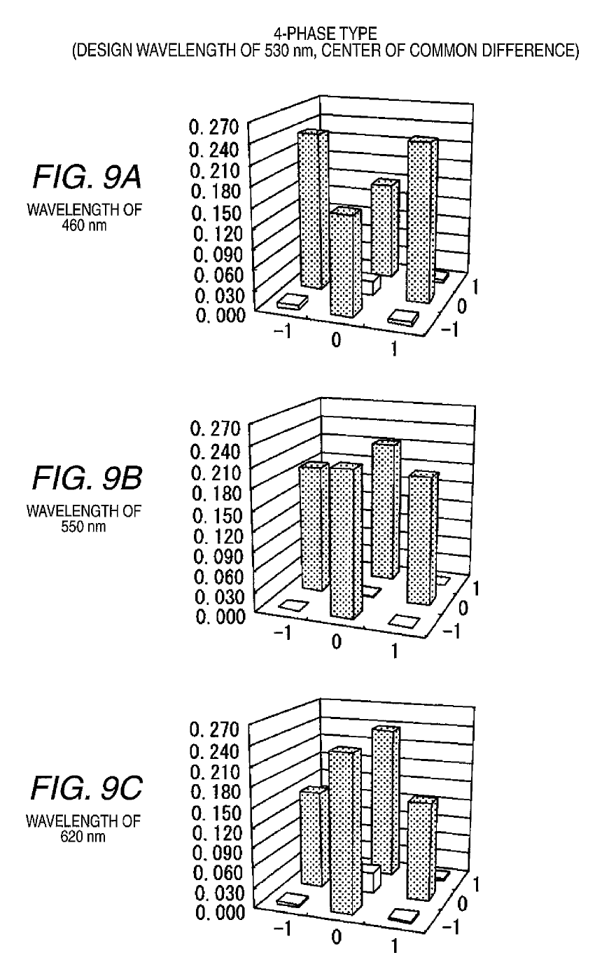

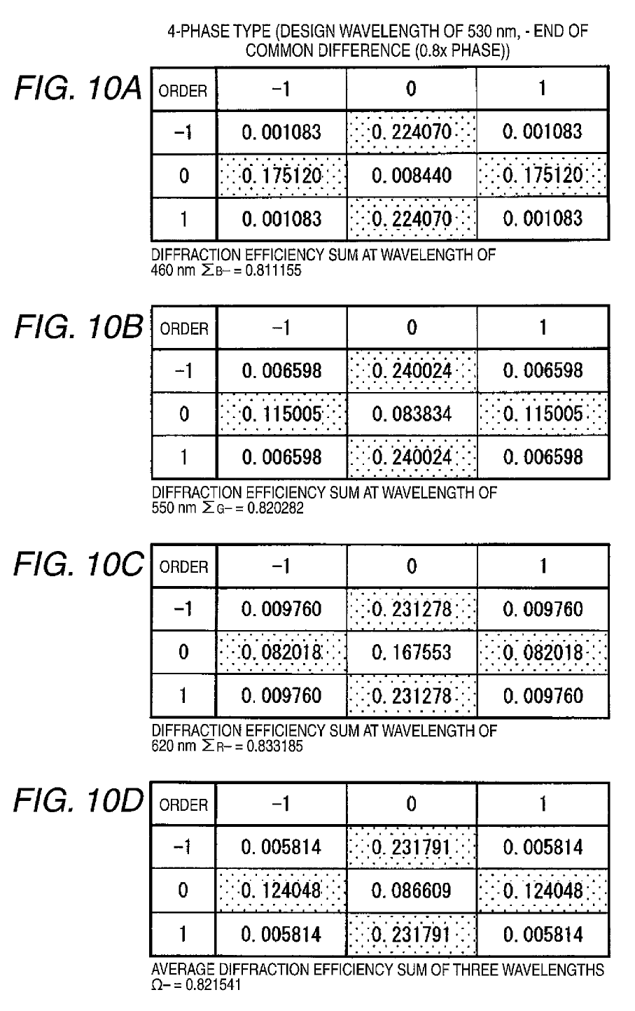

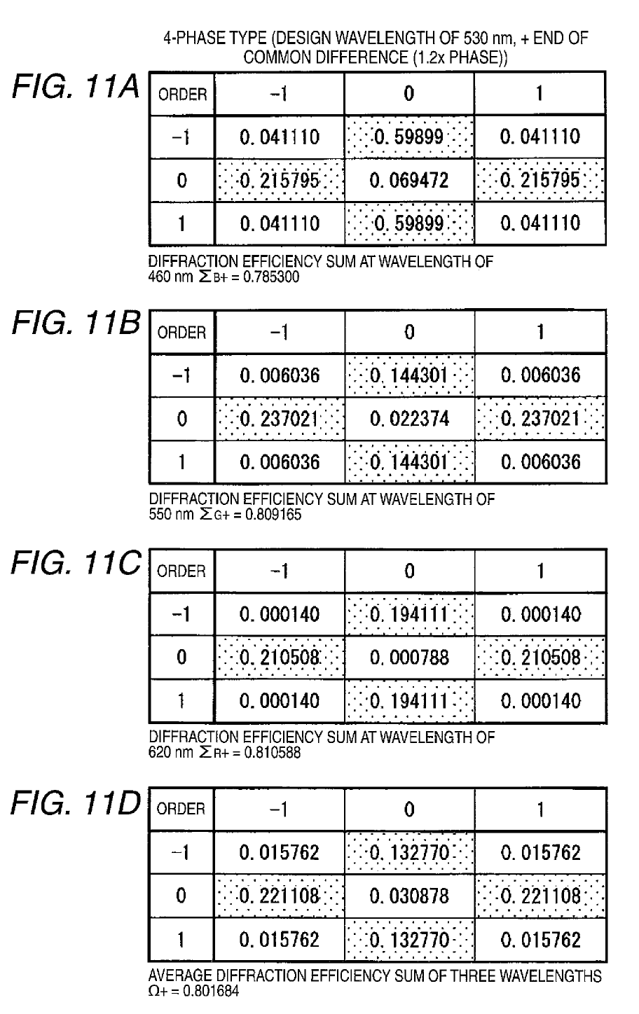

The obtained results are shown in FIGS. 5 to 11D. FIGS. 5 and 6 show diffraction efficiencies of −5th to +5th orders at a wavelength of 550 nm (φ=π/2) in a design of a design wavelength of 550 nm and a phase φ=π/2. FIG. 7 shows diffraction efficiency sums of −5th to +5th, −3rd to +3rd, and −1st to +1st orders. FIGS. 8A to 8D show diffraction efficiency sums and diffraction efficiencies at the center of the common difference when a design wavelength is 530 nm, where FIG. 8A is a case of a wavelength of 460 nm, FIG. 8B is a case of a wavelength of 550 nm, FIG. 8C is a case of a wavelength of 620 nm, and FIG. 8D shows arithmetic averages of the three wavelengths. Here, values in FIGS. 8A to 8D are represented from −1st order to +1st order. FIGS. 9A to 9C are bar graphs corresponding to FIGS. 8A to 8C, and the vertical axis and the horizontal axis represent diffraction efficiency and an order number, respectively. FIGS. 10A to 10D show diffraction efficiency sums and diffraction efficiencies at the negative end of the common difference when a design wavelength is 530 nm, where FIG. 10A is a case of a wavelength of 460 nm, FIG. 10B is a case of a wavelength of 550 nm, FIG. 10C is a case of a wavelength of 620 nm, and FIG. 10D shows arithmetic averages of the three wavelengths. FIGS. 11A to 11D show diffraction efficiency sums and diffraction efficiencies at the positive end of the common difference when a design wavelength is 530 nm, where FIG. 11A is a case of a wavelength of 460 nm, FIG. 11B is a case of a wavelength of 550 nm, FIG. 11C is a case of a wavelength of 620 nm, and FIG. 11D shows arithmetic averages of the three wavelengths.

In the four-phase type diffraction grating as shown in FIGS. 5 and 6, it may be observed that the incident light beam is separated into four beams of orders (−1, 0), (0, −1), (0, +1), and (+1, 0) when the phase φ=π/2. As described above, in the four-phase type, diffraction components including 0th order in −1st to +1st orders are effectively used. The reason is that the diffraction grating having four phase values is formed of unit gratings each having an array of two rows and two columns, in which regions of phases 0 and 2φ are arranged in one diagonal direction and regions of phases φ and 3φ are arranged in the other diagonal direction, and phases are different by 2φ(=π), that is, a half wavelength of λ/2, thereby causing interference to eliminate light waves in the diagonal direction.

Furthermore, in the design wavelength of 550 nm, each of diffraction efficiencies of four beams is adjusted to 0.2026. Thus, diffraction efficiency sum of those increases to 0.810569. Accordingly, when the incident light is intended to be separated into four beams, the four-phase type diffraction grating is more effective than a two-phase type diffraction grating or a three-phase type diffraction grating to be described later.

In the four-phase type diffraction grating, the design wavelength is 550 nm, the diffraction efficiency sum Σ of −1st to +1st orders exceeds 0.81, and energy of high order diffracted light having a second or more order is small. Thus, it may be said that the four-phase type diffraction grating has an excellent characteristic as a low-pass filter.

In addition, when the design wavelength is shifted from 550 nm to 530 nm, an average diffraction efficiency sum Ω at the center of the common difference is 0.811142 as shown in FIG. 8D, an average diffraction efficiency sum Ω₋ at the negative end of the common difference is 0.821541 as shown in FIG. 10D, and an average diffraction efficiency sum Ω₊ at the positive end of the common difference is 0.801684 as shown in FIG. 11D. From these results, it would appear that no matter what a width of the common difference corresponds to 20 percent of the phase φ, variance of the average diffraction efficiency sum of the three wavelengths at the center of the common difference and the ± ends of the common difference may be suppressed to 1.3% or less.

### Example 2

In Example 2, when the diffraction grating low-pass filter 2 having three phase values (0, Ψ, and 2φ) according to the second exemplary embodiment is used, variance of the diffraction efficiency at three wavelengths is estimated. Specifically, first, when a=115/90, Ψ=φ=115°, and 2φ=230° in a design of a design wavelength of 550 nm and a phase Ψ=φ=a·(π/2) as a desired example, diffraction efficiencies at a wavelength of 550 nm, a wavelength of 460 nm, and a wavelength of 620 nm are measured. Thereby, diffraction efficiency sums of the three wavelengths are obtained, and an average diffraction efficiency sum of the three wavelengths is calculated.

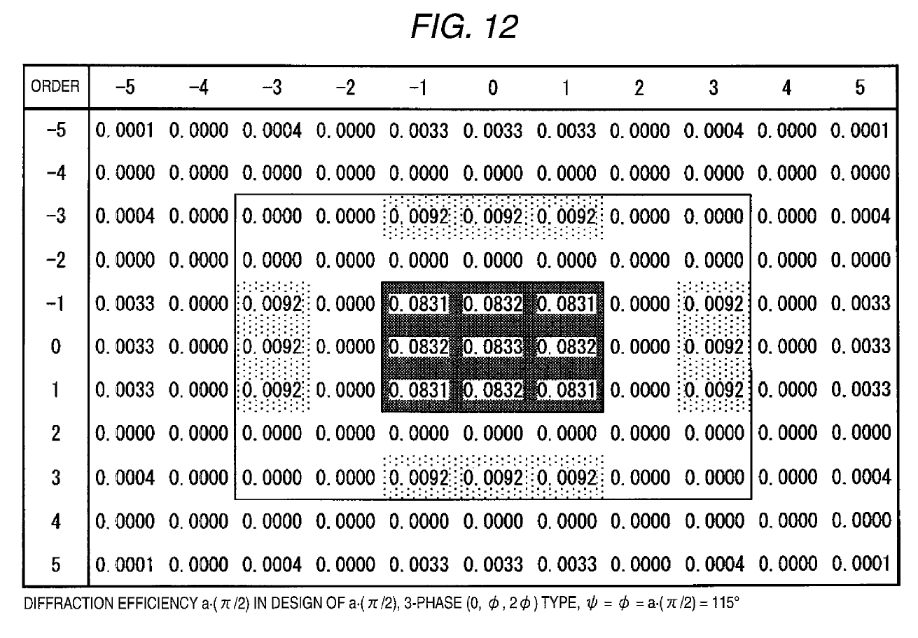

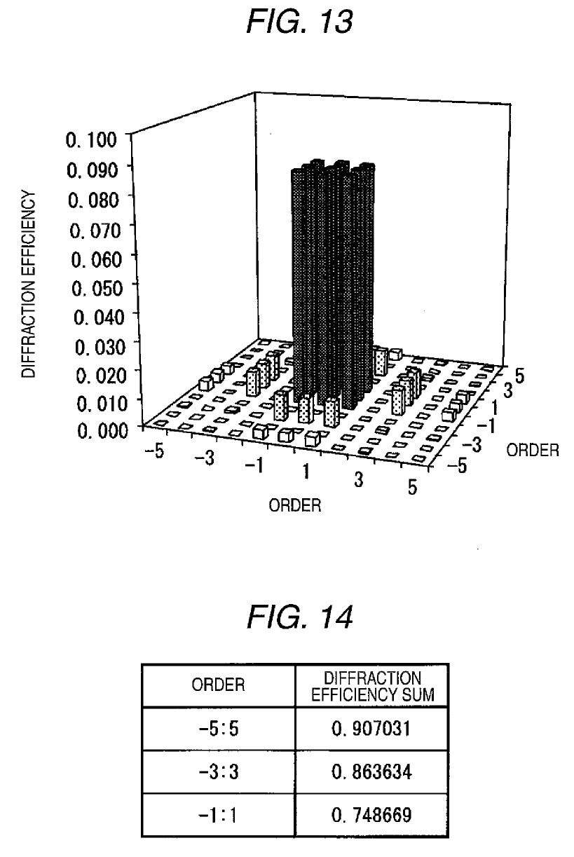

The obtained results are shown in FIGS. 12 to 16C. FIGS. 12 and 13 show diffraction efficiencies of −5th to +5th orders at a wavelength of 550 nm when a=115/90, Ψ=φ=115°, and 2φ=230° in a design of a design wavelength of 550 nm and a phase Ψ=φ=a·(π/2). FIG. 14 shows diffraction efficiency sums of −5th to +5th, −3rd to +3rd, and −1st to +1st orders.

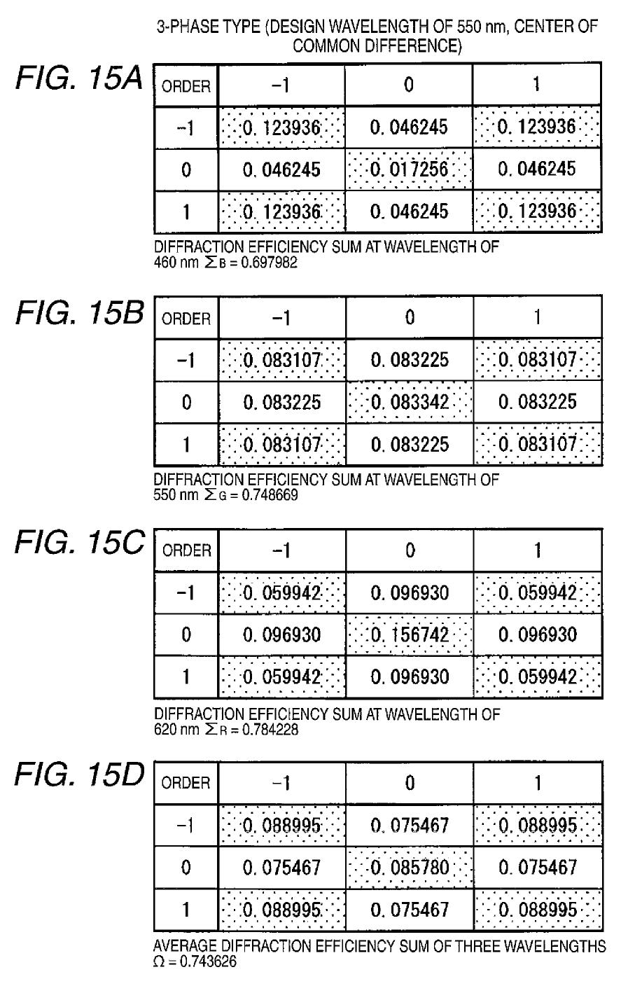

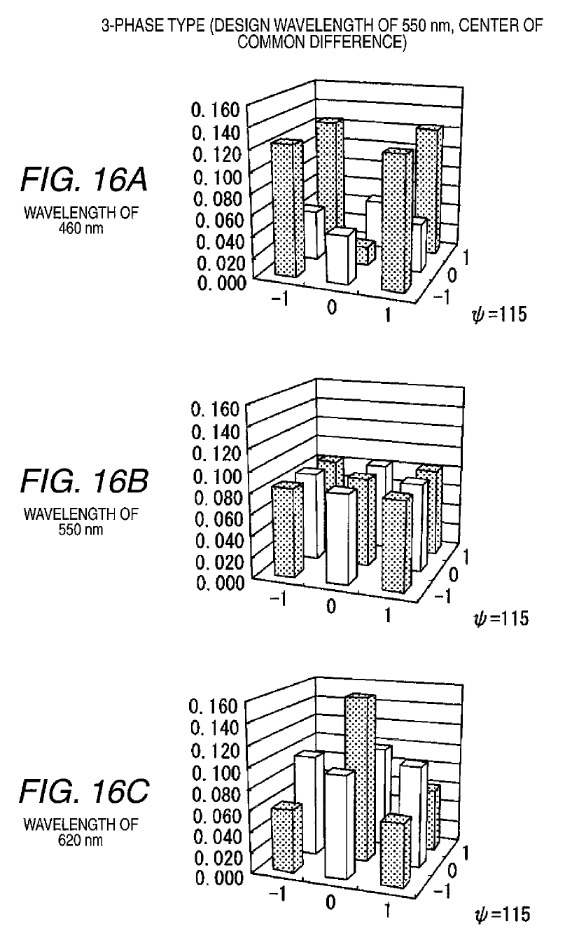

FIGS. 15A to 15D show diffraction efficiency sums and diffraction efficiencies at the center of the common difference when a design wavelength is 550 nm, where FIG. 15A is a case of a wavelength of 460 nm, FIG. 15B is a case of a wavelength of 550 nm, FIG. 15C is a case of a wavelength of 620 nm, and FIG. 15D shows arithmetic averages of the three wavelengths. Here, values in the drawing are represented from −1st order to +1st order. FIGS. 16A to 16C are bar graphs corresponding to FIGS. 15A to 15C, and the vertical axis and the horizontal axis represent diffraction efficiency and an order number, respectively.

In the three-phase type diffraction grating as shown in FIGS. 12 and 13, it may be observed that the incident light beam is separated into nine beams of −1st to +1st orders in design of a wavelength of 550 nm and a phase Ψ=φ=a·(π/2) when a=115/90, Ψ=φ=115°, and 2φ=230°. Furthermore, each of diffraction efficiencies of nine beams is substantially adjusted to 0.0832. Thus, diffraction efficiency sum of the nine beams becomes 0.748669. Hence, in particular, the three-phase type diffraction grating is appropriately used as a diffraction grating low-pass filter for separating the incident light beam into nine beams.

However, it may be observed that heights of the nine beams mutually coincide at a wavelength of 550 nm as shown in FIG. 16B, but efficiency of 0th order diffracted light in the diffraction efficiency at a wavelength of 460 nm is very low as shown in FIG. 16A, and efficiency of 0th order diffracted light in the diffraction efficiency at a wavelength of 620 nm is very high as shown in FIG. 16C. Hence a ratio of a diffraction efficiency sum at a wavelength of 460 nm to a diffraction efficiency sum at a wavelength of 620 nm of −1st to +1st orders reaches 12.4%, and the long wavelength side becomes higher.

Accordingly, the design wavelength is shifted to 610 nm, and diffraction efficiency sums Σ_{B}, Σ_{G}, and Σ_{R} at the center of the common difference of the three wavelengths are calculated. Thereby, an average diffraction efficiency sum Ω of the three wavelengths is calculated. In this case, a=115/90=1.277778, a phase 2φ=230° since a phase Ψ=φ=a (π/2)=115°, and a phase Ψ=a(aπ/2)=115 a=146.94° or a phase Ψ=(2−a) 115=83.06° by multiplying the phase Ψ by a or (2−a). In addition, an average diffraction efficiency sum Ω₋ of the three wavelengths is calculated from diffraction efficiency sums Σ_{B-}, Σ_{G-}, and Σ_{R-} of the wavelengths at negative end (0.9375 times the phase) of the common difference, at the design wavelength of 610 nm. Likewise, an average diffraction efficiency sum Ω₊ of the three wavelengths is calculated from diffraction efficiency sums Σ_{B+}, Σ_{G+}, and Σ_{R+} of the wavelengths at positive end (1.0625 times the phase) of the common difference.

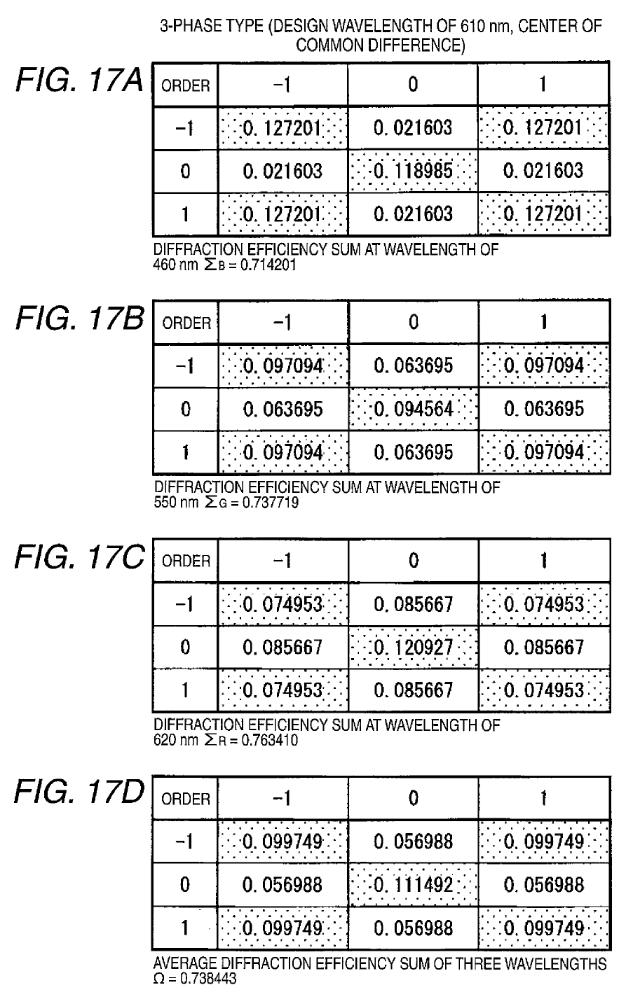

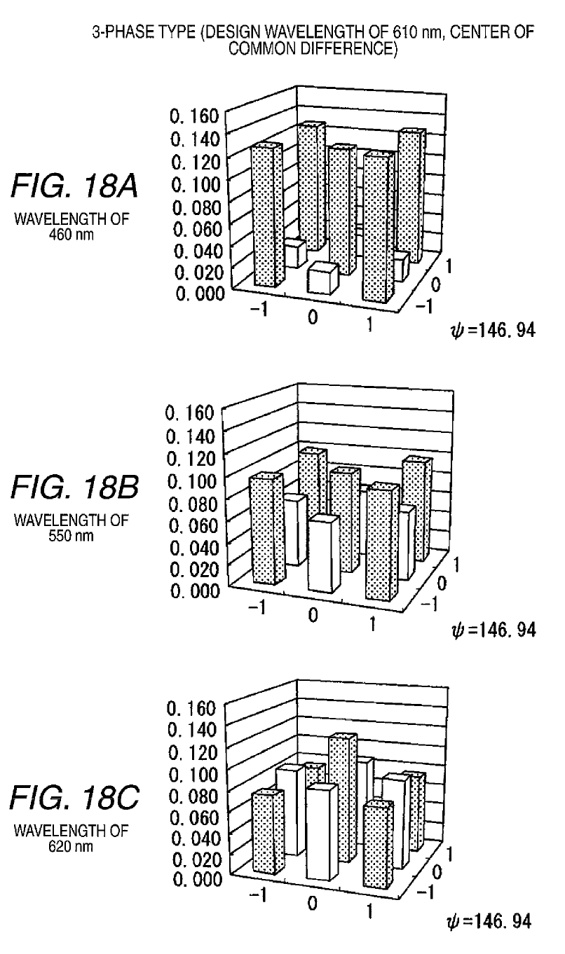

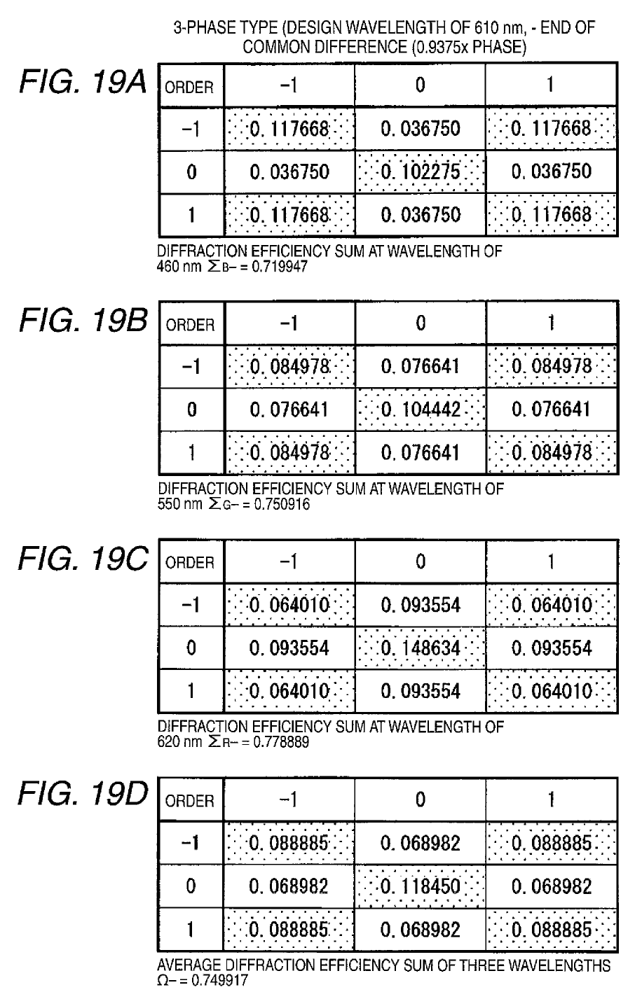

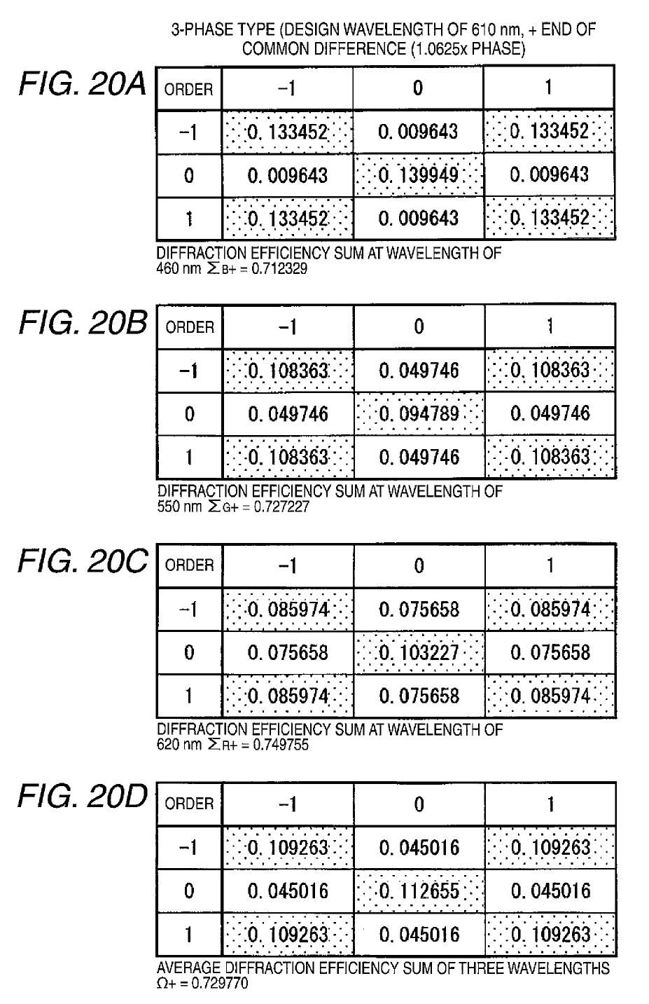

The obtained results are shown in FIGS. 17A to 20. FIGS. 17A to 17D show diffraction efficiency sums and diffraction efficiencies at the center of the common difference when a design wavelength is 610 nm, where FIG. 17A is a case of a wavelength of 460 nm, FIG. 17B is a case of a wavelength of 550 nm, FIG. 17C is a case of a wavelength of 620 nm, and FIG. 17D shows arithmetic averages of the three wavelengths. FIGS. 18A to 18C are bar graphs corresponding to FIGS. 17A to 17C, and the vertical axis and the horizontal axis represent diffraction efficiency and an order number, respectively. FIGS. 19A to 19D show diffraction efficiency sums and diffraction efficiencies at the negative end of the common difference when a design wavelength is 610 nm, where FIG. 19A is a case of a wavelength of 460 nm, FIG. 19B is a case of a wavelength of 550 nm, FIG. 19C is a case of a wavelength of 620 nm, and FIG. 19D shows arithmetic averages of the three wavelengths. FIGS. 20A to 20D show diffraction efficiency sums and diffraction efficiencies at the positive end of the common difference when a design wavelength is 610 nm, where FIG. 20A is a case of a wavelength of 460 nm, FIG. 20B is a case of a wavelength of 550 nm, FIG. 20C is a case of a wavelength of 620 nm, and FIG. 20D shows arithmetic averages of the three wavelengths.

As described above, when a design wavelength is 610 nm and a phase Ψ=146.94° (or Ψ=83.06°), a diffraction efficiency of the 0th order diffracted light at each of the three wavelengths increases, and particularly a diffraction efficiency of the 0th order diffracted light on the short wavelength side increases. Thereby, balance of the separated nine beams becomes better, and the diffraction efficiency sums of the three wavelengths entirely increases. In addition, an average diffraction efficiency sum Ω at the center of the common difference becomes 0.738443 as shown in FIG. 16D, an average diffraction efficiency sum Ω− at the negative end of the common difference becomes 0.749917 as shown in FIG. 19D, and an average diffraction efficiency sum Ω₊ at the positive end of the common difference becomes 0.729770 as shown in FIG. 20D. From these results, it would appear that variance of the average diffraction efficiency sum of the three wavelengths at the center of the common difference and the ± ends of the common difference may be suppressed to about 1.5%.

Furthermore, in the three-phase (0, Ψ, and 2φ) type diffraction grating, a phase difference is not n, that is, 180° in a diagonal direction and row and column directions in any case where φ=Ψ or φ≠Ψ. Thus, the 0th order diffracted light is not eliminated. However, even when the 0th order diffracted light exists as described above, a height H of the grating is designed on the basis of the conditional expression (6) mentioned above. For example, when a phase is a π=230°, a height of the grating is also defined as a·H depending thereon.

### Example 3

In Example 3, when the diffraction grating low-pass filter 3 having two phase values (0 and φ) according to the third exemplary embodiment is used, variance of the diffraction efficiency at three wavelengths is estimated. Specifically, first, when one-dimensional Dammann type diffraction gratings having a phase (0, π) are two-dimensionally arranged in a lattice shape in a design of a design wavelength of 550 nm and a phase φ=π as a desired example, diffraction efficiencies at a wavelength of 550 nm, a wavelength of 460 nm, and a wavelength of 620 nm are measured. Thereby, diffraction efficiency sums of the three wavelengths are obtained, and an average diffraction efficiency sum of the three wavelengths is calculated.

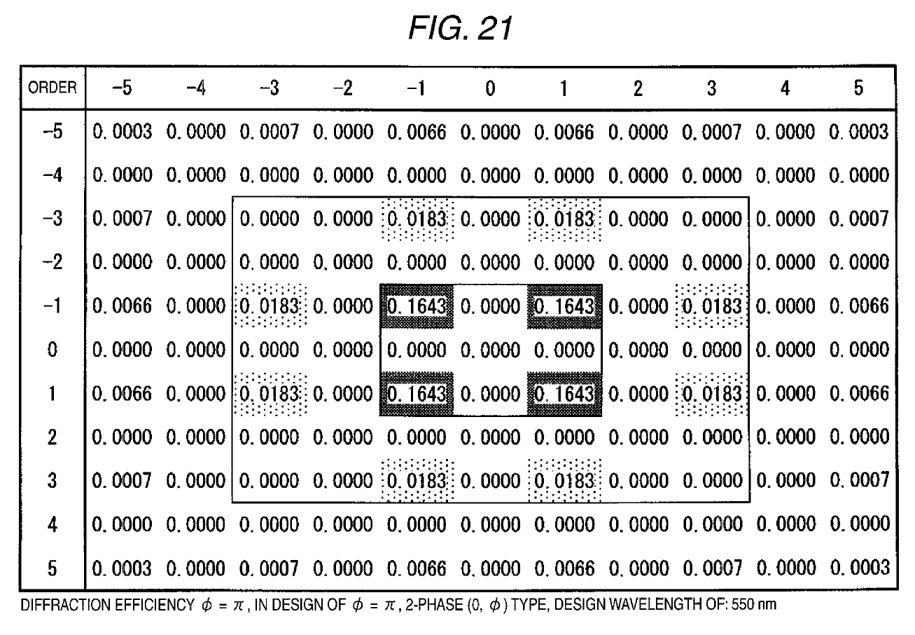

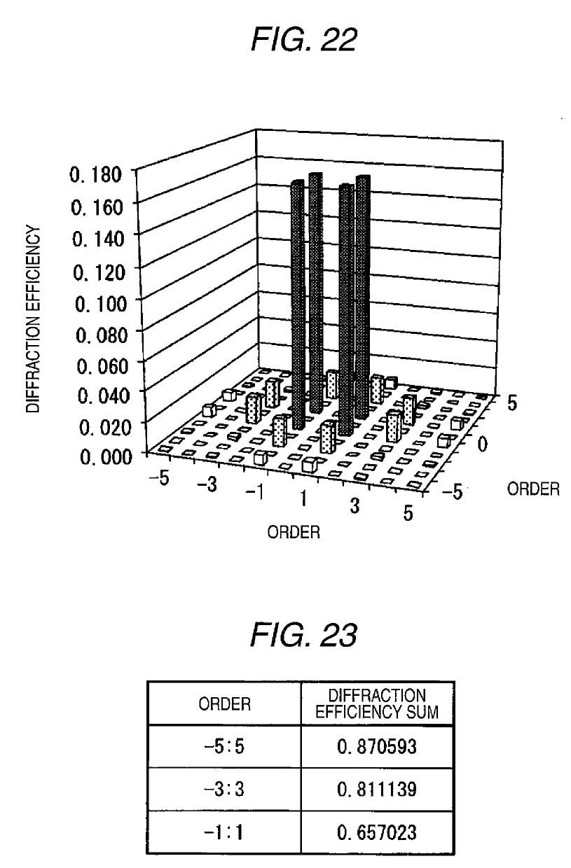

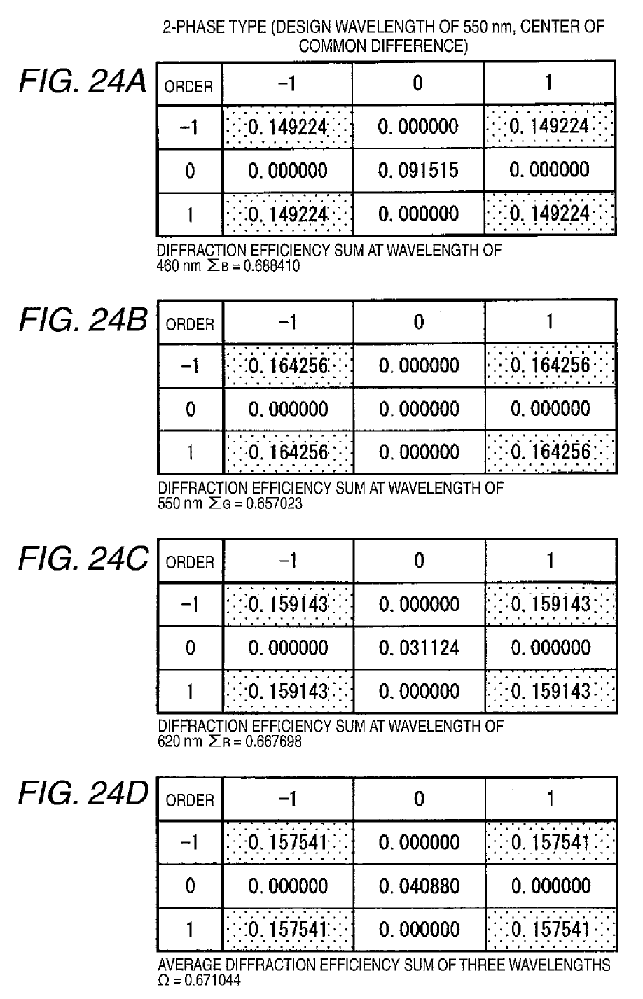

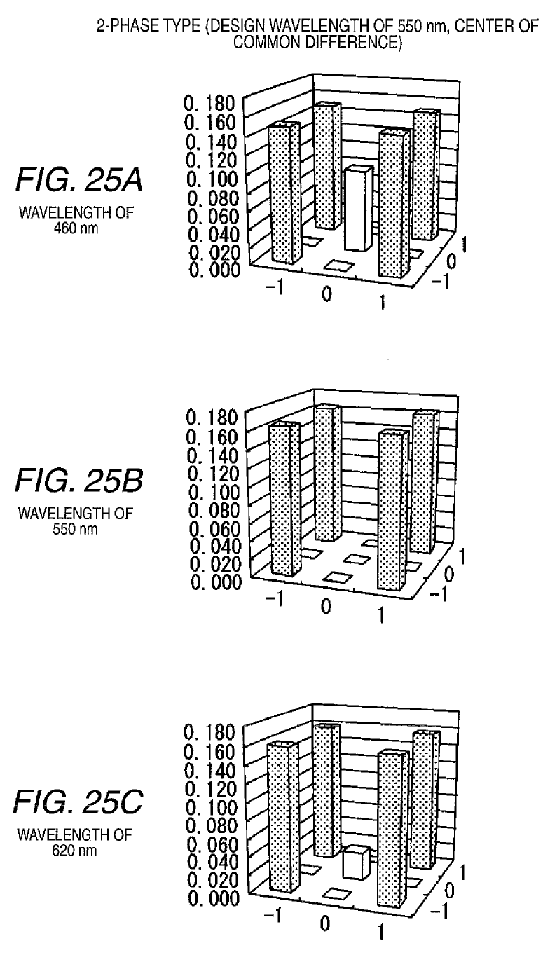

The obtained results are shown in FIGS. 21 to 25C. FIGS. 21 and 22 show diffraction efficiencies of −5th to +5th orders at a wavelength of 550 nm in a design of a design wavelength of 550 nm and a phase φ=π. FIG. 23 shows diffraction efficiency sums of −5th to +5th, −3rd to +3rd, and −1st to +1st orders. FIGS. 24A to 24D show diffraction efficiency sums and diffraction efficiencies at the center of the common difference when a design wavelength is 550 nm, where FIG. 24A is a case of a wavelength of 460 nm, FIG. 24B is a case of a wavelength of 550 nm, FIG. 24C is a case of a wavelength of 620 nm, and FIG. 24D shows arithmetic averages of the three wavelengths. FIGS. 25A to 25C are bar graphs corresponding to FIGS. 24A to 24C, and the vertical axis and the horizontal axis represent diffraction efficiency and an order number, respectively.

In the two-phase type diffraction grating as shown in FIGS. 21 and 22, it may be observed that the incident light beam is separated into four beams of orders (−1, −1), (−1, +1), (+1, −1), and (+1, +1) among −1st to +1st order diffracted light beams in a design of a wavelength of 550 nm and a phase φ=π. The reason is that the two-phase type diffraction grating has the same phase values arranged in the diagonal direction and has a phase difference of π in row and column directions, and thus an optical path length difference in row and column directions is a half wavelength of λ/2, thereby attenuating and eliminating the 0th order diffracted light in row and column directions by interference.

Furthermore, in the design wavelength of 550 nm, each of diffraction efficiencies of four beams is adjusted to 0.164256. Thus, diffraction efficiency sum of those becomes 0.657023. Accordingly, when the incident light is intended to be separated into four beams, it may be observed that better diffraction efficiency may be obtained with a simple grating configuration.

Here, in accordance with increase or decrease in design wavelength, a phase also becomes more or less than π. Thereby, the 0th order diffracted light is added, and the number of separated beams becomes five. In this case, as a specific example, when a phase φ=0.755π=135.9° and a phase φ=1.245π=224.1°, the incident light is separated into five beams of which diffraction efficiencies substantially coincide at about 0.141. In the two-phase type, diffraction efficiency on a short wavelength side less than the design wavelength of 550 nm is more sensitive of deviation of phase, and mostly diffraction efficiency of the 0th order diffracted light varies. Accordingly, the design wavelength is shifted from 550 nm to 520 nm so that diffraction efficiencies of five beams having a wavelength of 620 nm at the negative end (0.9 times the phase) of the common difference are equal to the diffraction efficiencies of five beams having a wavelength of 460 nm at the positive end (1.1 times the phase) thereof. In the design wavelength of 520 nm, diffraction efficiency sums Σ_{B}, Σ_{G}, and Σ_{R} at the center of the common difference of the three wavelengths are calculated. Thereby, an average diffraction efficiency sum Ω of the three wavelengths is calculated. In addition, an average diffraction efficiency sum Ω₋ of the three wavelengths is calculated from diffraction efficiency sums Σ_{B-}, Σ_{G-}, and Σ_{R-} at negative end of the common difference. Likewise, an average diffraction efficiency sum Ω₊ of the three wavelengths is calculated from diffraction efficiency sums Σ_{B+}, Σ_{G+}, and Σ_{R+} at positive end of the common difference.

The obtained results are shown in FIGS. 26A to 31C. FIGS. 26A to 26D show diffraction efficiency sums and diffraction efficiencies at the center of the common difference when a design wavelength is 520 nm, where FIG. 26A is a case of a wavelength of 460 nm, FIG. 26B is a case of a wavelength of 550 nm, FIG. 26C is a case of a wavelength of 620 nm, and FIG. 26D shows arithmetic averages of the three wavelengths. FIGS. 27A to 27C are bar graphs corresponding to FIGS. 26A to 26C, and the vertical axis and the horizontal axis represent diffraction efficiency and an order number, respectively. FIGS. 28A to 28D show diffraction efficiency sums and diffraction efficiencies at the negative end of the common difference when a design wavelength is 520 nm, where FIG. 28A is a case of a wavelength of 460 nm, FIG. 28B is a case of a wavelength of 550 nm, FIG. 28C is a case of a wavelength of 620 nm, and FIG. 28D shows arithmetic averages of the three wavelengths. FIGS. 29A to 29C are bar graphs corresponding to FIGS. 28A to 28C, and the vertical axis and the horizontal axis represent diffraction efficiency and an order number, respectively. FIGS. 30A to 30D show diffraction efficiency sums and diffraction efficiencies at the positive end of the common difference when a design wavelength is 520 nm, where FIG. 30A is a case of a wavelength of 460 nm, FIG. 30B is a case of a wavelength of 550 nm, FIG. 30C is a case of a wavelength of 620 nm, and FIG. 30D shows arithmetic averages of the three wavelengths. FIGS. 31A to 31C are bar graphs corresponding to FIGS. 30A to 30C, and the vertical axis and the horizontal axis represent diffraction efficiency and an order number, respectively.

When the design wavelength is set by 520 nm as described above, an average diffraction efficiency sum Ω at the center of the common difference is 0.669775 as shown in FIG. 26D, an average diffraction efficiency sum Ω₋ at the negative end of the common difference is 0.679397 as shown in FIG. 28D, and an average diffraction efficiency sum Ω₊ at the positive end of the common difference is 0.675079 as shown in FIG. 30D. From these results, it would appear that variance of the average diffraction efficiency sum of the three wavelengths at the center of the common difference and the ± ends of the common difference may be suppressed to about 1.44%.

As described above, by satisfying the conditional expressions corresponding to the respective phases of the examples mentioned above, variation common difference of each phase is optimized. Thus, it is observed that variance of diffraction efficiency depending on a wavelength may be reduced.

As described above, the present invention is described with reference to the several exemplary embodiments and examples, but the present invention is not limited to the exemplary embodiments and examples, and may be modified in various forms. For example, the present invention is not limited to the above-mentioned diffraction grating having a phase array of two rows and two columns. In addition, the diffraction efficiency does not varies even when the phase array is rotated by 90° or 180°, the left side and the right side thereof are reversed (mirror conversion), and the refractive indexes N1 and N2 are changed.

Furthermore, in the exemplary embodiments, as an example, it is described that two regions having refractive indexes N1 and N2 different from each other are formed as the refractive index variation region in the transparent substrate. However, the present invention is not limited to this, and three or more regions may be formed to have different refractive indexes.

In addition, in the exemplary embodiments, the OLPF of the imaging device serving as a diffraction grating low-pass filter according to the present invention is described as an example. However, the present invention is not limited to this, and when required precision is satisfied, the present invention may be applicable to a phase shift mask used in an exposure process for forming two-dimensional micro periodic structure, a tracking position control for an optical system using an optical disk such as CD and DVD for recording and reproducing information, a correction process for non-uniformity of illumination intensity in a projection illumination system, a bifurcating/demultiplexing and multiplexing operations in a waveguide of wavelength division multiplex, and the like.

What is claimed is:

1. A diffraction grating low-pass filter comprising:
a transparent substrate; and
a diffraction grating portion provided in the transparent substrate,
wherein the diffraction grating portion has a refractive index variation region having a refractive index different from that of the transparent substrate and includes a plurality of unit gratings, and
wherein each of the plurality of unit gratings includes a plurality of regions which is arranged in two rows and two columns and which have phases depending on optical path lengths between the regions.

2. The diffraction grating low-pass filter according to claim 1, wherein two regions arranged in one diagonal direction in each of the plurality of unit gratings have phases of 0 and 2φ, the other two regions arranged in the other diagonal direction in each of the plurality of unit gratings have phases of φ and 3φ,
wherein each of the plurality of the unit gratings satisfies the following conditional expression (1):

|mφ−mπ/2|≦(mπ/2)/5 (1), and
wherein m is an integer of 1 to 3.

3. The diffraction grating low-pass filter according to claim 1, wherein two region arranged in one diagonal direction in each of the plurality of unit gratings have phases of unit grating have phases of 0 and 2φ, the other region arranged in other diagonal direction in each of the plurality of unit gratings have phases of unit grating have phases of φ and 3φ,
wherein each of the plurality of the unit grating satisfies the following conditional expression (2) or (3) and the following conditional expression (4):

|Ψ−a·(aπ/2)|≦a·(aπ/2)/16 (2),

|Ψ−b·(aπ/2)|≦b·(aπ/2)/16 (3),

|2φ−(aπ)|≦(aπ)/16 (4), and
wherein a=115/90 and b=(2−a).

4. The diffraction grating low-pass filter according to claim 1, wherein the plurality of regions are alternately arranged phases 0 and φ, and
wherein each of the plurality of the unit grating satisfies the following conditional expression (5):

|φ−π|≦π/10 (5).

5. The diffraction grating low-pass filter according to claim 1 which satisfies the following conditional expression (6):
H·|N2−N1|=π/2 (6), and
wherein N1 is a refractive index of the transparent substrate, N2 is a refractive index of the refractive index variation region, H is a height of the grating corresponding to a phase π, and λ is a central wavelength.

6. An imaging apparatus comprising:
an imaging device; and
a diffraction grating low-pass filter according to claim 1 being disposed on a light receiving surface of the imaging device.
